(19) United States
(12) Patent Application Publication
(10) Pub. No.: US 2024/0334308 A1
(43) Pub. Date: Oct. 3, 2024

(54) GRID COMPUTING MANAGEMENT DEVICE AND TRANSMISSION ROUTE SWITCHING METHOD

(71) Applicant: PANASONIC AUTOMOTIVE SYSTEMS CO., LTD., Kanagawa (JP)

(72) Inventors: Koyo MINAMIKAWA, Osaka (JP); Naoki OTSUKA, Kanagawa (JP)

(21) Appl. No.: 18/617,401

(22) Filed: Mar. 26, 2024

(30) Foreign Application Priority Data
Mar. 29, 2023 (JP) 2023-053889

(51) Int. Cl. H04W 40/28; H04W 4/40

(52) U.S. Cl. CPC H04W 40/28; H04W 4/40

(57) ABSTRACT

A grid computing management device includes a communication interface data-communicably connected with a base station/management server capable of data communication with each of a plurality of in-vehicle devices and storing a program and data necessary for executing grid computing processing by the in-vehicle device, and a processor. The processor acquires a communication status between a specific in-vehicle device, which is one of the plurality of in-vehicle devices, and the base station/management server, and switches a transmission route for at least one of the program and the data based on the communication status, and instructs transmission from the base station/management server to the specific in-vehicle device.

### TECHNICAL FIELD

The present disclosure relates to a grid computing management device and a transmission route switching method.

### BACKGROUND ART

A grid computing system is known as an example of a distributed processing system. In the grid computing system, a plurality of information processing devices are connected via a network, and by causing each of the information processing devices to perform a target process, high-speed processing as a whole is possible even if performance of each information processing device is low. Performance of an electronic device such as a smartphone or an in-vehicle device has advanced in recent years, and use of such electronic device as one of information processing devices that constitute grid computing is being studied.

Patent Literature 1 discloses an in-vehicle device that constitutes a distributed processing system, which is requested by a server to execute processing during traveling. The in-vehicle device stores in advance a program and data necessary for requested processing, detects a stop of a vehicle on which the in-vehicle device is mounted, and updates the stored program and/or data while the vehicle is stopped.

### CITATION LIST

### Patent Literature

Patent Literature 1: JP2007-34815A

### SUMMARY OF INVENTION

An information processing device that constitutes an existing grid computing system is implemented by a machine such as a desktop personal computer. However, when a mobile terminal such as a smartphone or an in-vehicle device is used as an information processing device that constitutes a grid computing system, there are the following problems. Specifically, as the mobile terminal moves, a communication status with a server machine that supervises grid computing or with other mobile terminals may change from moment to moment. Therefore, when the communication status deteriorates, there is a possibility that communication is interrupted and operation as a grid computing system is not guaranteed. Further, in processing of grid computing, the information processing device needs to hold a program and data necessary for performing the processing in advance, but when data transfer takes time depending on the communication status, time for processing (that is, calculation) is not sufficient, and benefits of distributed processing cannot be utilized.

The present disclosure has been made in view of the circumstances described above, and an object of the present disclosure is to provide a grid computing management device, a transmission route switching method, and a program that adaptively switch a transmission route for data according to a communication status with a mobile terminal.

The present disclosure provides a grid computing management device including a communication interface data-communicably connected with a base station/management server, the base station/management server being capable of data communication with each of a plurality of in-vehicle devices and storing a program and data necessary for executing grid computing processing by the in-vehicle device; and a processor. The processor acquires a communication status between a specific in-vehicle device, which is one of the plurality of in-vehicle devices, and the base station/management server, and switches a transmission route for at least one of the program and the data based on the communication status, and instructs transmission from the base station/management server to the specific in-vehicle device.

Further, the present disclosure provides a transmission route switching method executed by a grid computing management device. The transmission route switching method includes data-communicably connecting to a base station/management server that is capable of data communication with each of a plurality of in-vehicle devices and stores a program and data necessary for executing grid computing processing by the in-vehicle device; acquiring a communication status between a specific in-vehicle device, which is one of the plurality of in-vehicle devices, and the base station/management server; and switching a transmission route for at least one of the program and the data based on the communication status and instructing transmission from the base station/management server to the specific in-vehicle device.

Further, the present disclosure provides a computer readable storage medium on which a program is stored. The program causes a grid computing management device, which is a computer, to implement processing of data-communicably connecting to a base station/management server that is capable of data communication with each of a plurality of in-vehicle devices and stores a program and data necessary for executing grid computing processing by the in-vehicle device; processing of acquiring a communication status between a specific in-vehicle device, which is one of the plurality of in-vehicle devices, and the base station/management server; and processing of switching a transmission route for at least one of the program and the data based on the communication status, and instructing transmission from the base station/management server to the specific in-vehicle device.

According to the present disclosure, a transmission route for data can be adaptively switched according to a communication status with a mobile terminal.

### BRIEF DESCRIPTION OF DRAWINGS

FIG. 1 is a diagram illustrating a system configuration example of a grid computing system;

FIG. 2 is a block diagram illustrating a hardware configuration example of a grid computing management device according to Embodiment 1;

FIG. 3 is a block diagram illustrating a hardware configuration example of an in-vehicle device;

FIG. 4 is a table illustrating an example of a switching pattern of transmission routes for a processing program and processing data;

FIG. 5A is a diagram illustrating an operation outline example of a route pattern P1;

FIG. 5B is a sequence diagram illustrating, in time series, an operation procedure example of the grid computing system according to the route pattern P1;

FIG. 6A is a diagram illustrating an operation outline example of a route pattern P2;

FIG. 6B is a sequence diagram illustrating, in time series, an operation procedure example of the grid computing system according to the route pattern P2;

FIG. 7A is a diagram illustrating an operation outline example of a route pattern P3;

FIG. 7B is a sequence diagram illustrating, in time series, an operation procedure example of the grid computing system according to the route pattern P3;

FIG. 8 is a flowchart illustrating, in time series, an operation procedure of the grid computing management device;

FIG. 9 is a block diagram illustrating a hardware configuration example of a grid computing management device according to a modification of Embodiment 1;

FIG. 10 is a sequence diagram illustrating, in time series, an operation procedure example of a grid computing system according to a route pattern P1 according to the modification of Embodiment 1;

FIG. 11 is a sequence diagram illustrating, in time series, an operation procedure example of the grid computing system according to a route pattern P2 according to the modification of Embodiment 1; and

FIG. 12 is a sequence diagram illustrating, in time series, an operation procedure example of the grid computing system according to a route pattern P3 according to the modification of Embodiment 1.

### DESCRIPTION OF EMBODIMENTS

Hereinafter, an embodiment in which a grid computing management device, a transmission route switching method, and a program according to the present disclosure are specifically disclosed will be described in detail with reference to the drawings as appropriate. However, unnecessarily detailed descriptions may be omitted. For example, detailed description of well-known matters and redundant description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matter described in the claims.

### Embodiment 1

### 1. Schematic Description of Grid Computing System

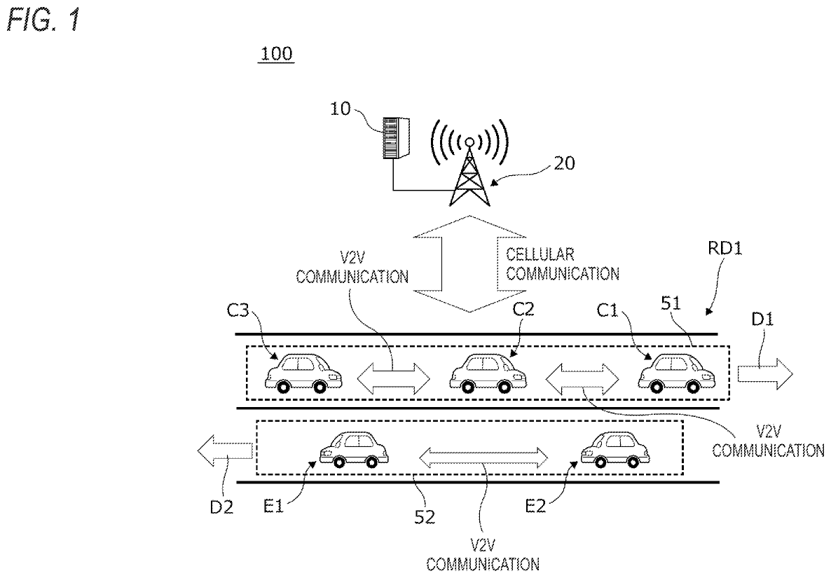

First, a schematic configuration of a grid computing system 100 according to the present embodiment will be described with reference to FIG. 1. FIG. 1 is a diagram illustrating a system configuration example of the grid computing system 100. In the grid computing system 100 according to the present embodiment, an in-vehicle device provided in each of a plurality of mobile objects, a grid computing management device 10, and a base station/management server 20 cooperate to form a grid computing system. The mobile object is, for example, a vehicle, and more specifically, an in-vehicle device mounted on the vehicle constitutes the grid computing system 100.

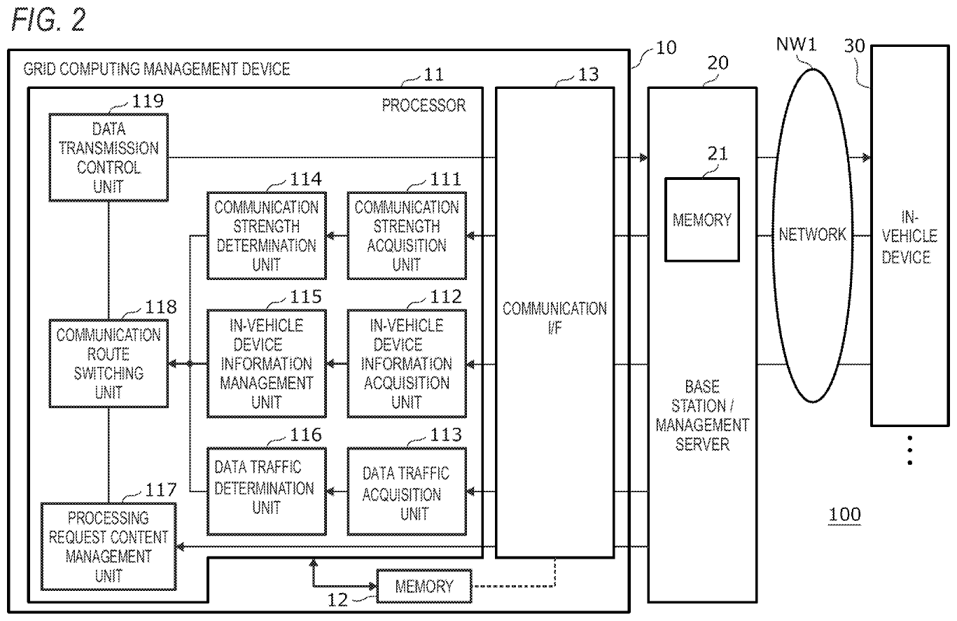

The grid computing system 100 includes a grid computing management device 10, a base station/management server 20, and a plurality of in-vehicle devices 30 (see FIG. 2). In the present embodiment, the grid computing management device 10 is provided at a location where the base station/management server 20 is provided, and is data-communicably connected to the base station/management server 20. The grid computing management device 10 and the base station/management server 20 are connected by a wired network. The wired network corresponds to, for example, at least one of a wired LAN, a wired WAN, and power line communication (PLC), and may have another network configuration capable of wired communication. The grid computing management device 10 and the base station/management server 20 may be connected not only by a wired network but also by a wireless network (described later).

The base station/management server 20 and each in-vehicle device 30 are data-communicably connected via a network NW1. The network NW1 is a wireless network. The wireless network corresponds to at least one of a wireless LAN such as Wi-Fi (registered trademark), a wireless WAN, and a cellular communication network such as 4G or 5G, and may have another network configuration capable of wireless communication. In FIG. 1, the wireless network is illustrated as a cellular communication network that enables wireless communication over a wide area.

In an example in FIG. 1, each of the vehicles C1, C2, and C3 is traveling in a direction D1 of a road RD1, and on an opposite side thereof, each of the vehicles E1 and E2 is traveling in a direction D2 of a road RD1. Here, a plurality of in-vehicle devices located within a physically close distance form a vehicle group, and the in-vehicle devices in the vehicle group can execute so-called vehicle-to-vehicle communication (V2V communication). Specifically, each of the vehicles C1, C2, and C3 forms a vehicle group 51, and V2V communication is possible between an in-vehicle device of the vehicle C1 and an in-vehicle device of the vehicle C2 and between an in-vehicle device of the vehicle C2 and an in-vehicle device of the vehicle C3. Similarly, each of the vehicles E1 and E2 forms a vehicle group 52, and V2V communication is possible between an in-vehicle device of the vehicle E1 and an in-vehicle device of the vehicle E2.

The grid computing management device 10 is implemented by a personal computer (PC), and acquires, via the base station/management server 20, a communication status between the base station/management server 20 and an in-vehicle device that is an execution entity for processing (calculation processing) to be performed in grid computing. The grid computing management device 10 switches a transmission route (in other words, transfer route) for a program and data to be transmitted to each in-vehicle device based on the acquired communication status. The grid computing management device 10 provides a program or data from the base station/management server 20 through cellular communication alone or provides in a communication mode that combines cellular communication and V2V communication, based on the switched transmission route. Further, the grid computing management device 10 determines a movement direction (for example, traveling direction) of each vehicle and forms one or more vehicles moving in the same direction as one vehicle group. A detailed configuration example of the grid computing management device 10 will be described later with reference to FIG. 2.

The base station/management server 20 is implemented by a server computer, receives a request for processing to be executed in the grid computing system 100, and divides the processing to be executed into a plurality of processing that can be executed in parallel. The base station/management server 20 allocates the divided processing to each of the traveling vehicles C1, C2, C3, E1, and E2. The base station/management server 20 holds, in a memory 21 (see FIG. 2), a program and data necessary for executing processing (calculation processing) to be performed in grid computing. The base station/management server 20 has a function as a base station for cellular communication, and performs cellular communication with an in-vehicle device in each vehicle which is a mobile object (node) for cellular communication. In the example in FIG. 1, the base station/management server 20 performs cellular communication with in-vehicle devices mounted on each of vehicles C1, C2, C3, E1, and E2. In the cellular communication, for example, a program and data necessary for executing processing (calculation processing) to be performed in grid computing (hereinafter, simply referred to as “processing program and processing data”) are sent from the base station/management server 20 to a corresponding in-vehicle device according to an instruction from the grid computing management device 10. Further, in the cellular communication, a result of processing (calculation processing) executed by the in-vehicle device is sent from the in-vehicle device to the base station/management server 20.

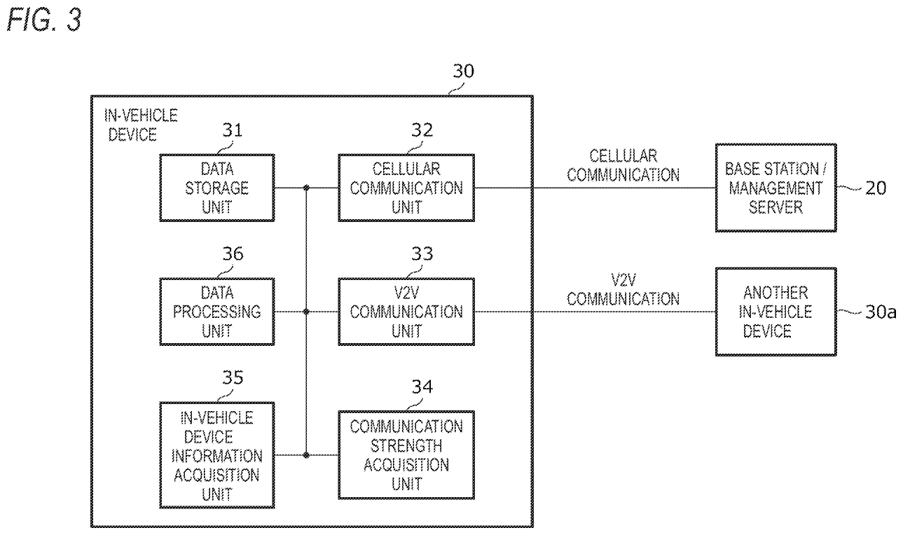

The in-vehicle device 30 is implemented by a computer device having a wireless communication function conforming to a predetermined wireless communication standard, and one in-vehicle device 30 is provided in one vehicle. The in-vehicle device 30 has a role as an execution entity for processing (calculation processing) to be performed in grid computing, and receives the allocated execution entity by the grid computing management device 10. When the in-vehicle device 30 acquires the processing program and the processing data necessary for executing processing thereof, the in-vehicle device 30 executes the processing (calculation processing) using the processing program and the processing data. The in-vehicle device 30 returns a processing result to the base station/management server 20 via cellular communication or V2V communication. A detailed configuration example of the in-vehicle device 30 will be described later with reference to FIG. 3.

### 2. Detailed Configuration Example of Grid Computing Management Device

Next, a configuration example of the grid computing management device 10 according to the present embodiment will be described with reference to FIG. 2. FIG. 2 is a block diagram illustrating a hardware configuration example of the grid computing management device 10 according to Embodiment 1.

The grid computing management device 10 has the following functions.

Specifically, the grid computing management device 10
(1) acquires, via the base station/management server 20, in-vehicle device information indicating information of one or more in-vehicle devices 30 existing within a communicable range of the base station/management server 20;
(2) sends, to the base station/management server 20, an instruction for transmitting the processing program and the processing data held by the base station/management server 20 from the base station/management server 20 to the in-vehicle device 30;
(3) switches a transmission route for the processing program and the processing data based on a communication status between the base station/management server 20 and the in-vehicle device 30; and
(4) estimates (in other words, predicts) a future communication status of a vehicle based on a movement direction and a speed of the vehicle included in the in-vehicle device information acquired in (2).

The grid computing management device 10 illustrated in FIG. 2 at least includes a processor 11, a memory 12, and a communication interface 13. In FIG. 2, the interface is abbreviated as “I/F”.

The processor 11 is implemented using, for example, an electronic device such as a central processing unit (CPU), a digital signal processor (DSP), or a field programmable gate array (FPGA). The processor 11 functions as a controller that controls overall operation of the grid computing management device 10, and performs control processing for supervising operation of each unit of the grid computing management device 10, input/output processing of data with each unit of the grid computing management device 10, arithmetic processing of data, and storage processing of data. The processor 11 operates according to a program and data stored in a read only memory (ROM) included in the memory 12, or temporarily stores, in a random access memory (RAM) included in the memory 12, data generated or acquired by the processor 11 using the RAM during operation.

The processor 11 functionally includes a communication strength acquisition unit 111, an in-vehicle device information acquisition unit 112, a data traffic acquisition unit 113, a communication strength determination unit 114, an in-vehicle device information management unit 115, a data traffic determination unit 116, a processing request content management unit 117, a communication route switching unit 118, and a data transmission control unit 119.

The communication strength acquisition unit 111 receives and acquires a value of a communication strength (for example, reception field strength such as received signal strength indicator (RSSI)) when the base station/management server 20 receives communication data (for example, bulk data of predetermined digit bits) from the in-vehicle device 30, via the base station/management server 20 and the communication interface 13. The communication strength is, for example, data of an index indicating good or poor of the communication status between the base station/management server 20 and the in-vehicle device 30. The communication strength may be measured at the time of communication of data other than the bulk data described above, or may be a value predicted from a value of the reception field strength such as RSSI. The communication strength acquisition unit 111 sends the data of the communication strength to the communication strength determination unit 114.

The in-vehicle device information acquisition unit 112 receives and acquires data of in-vehicle device information from the in-vehicle device 30 via the base station/management server 20 and the communication interface 13. The in-vehicle device information is, for example, various types of data such as a processing result executed by the in-vehicle device 30 in the grid computing system 100, a movement direction and a speed of a vehicle on which the in-vehicle device 30 is mounted, and a communication status between the in-vehicle device 30 and another in-vehicle device different from the in-vehicle device 30. The in-vehicle device information acquisition unit 112 sends the data of the in-vehicle device information to the in-vehicle device information management unit 115.

The data traffic acquisition unit 113 receives and acquires data of a data traffic of the base station/management server 20 via the base station/management server 20 and the communication interface 13. The data traffic is, for example, a latest data traffic of an own station thereof (that is, the base station/management server 20 itself) constantly monitored by the base station/management server 20, and is data of an index indicating whether a data traffic at a current time point exceeds a predetermined communication upper limit volume. The data traffic acquisition unit 113 sends the data of the data traffic to the data traffic determination unit 116.

The communication strength determination unit 114 acquires the data of the communication strength from the communication strength acquisition unit 111, and determines at least one of whether the communication strength is equal to or greater than a first threshold and whether the communication strength is less than a second threshold. The first threshold is a threshold for determining that the communication strength is “good”, that is, the communication status between the base station/management server 20 and the in-vehicle device 30 is good and communicable. The second threshold is a threshold for determining that the communication strength is “interrupted”, that is, the base station/management server 20 and the in-vehicle device 30 are in a state of non-communicable. The first threshold and the second threshold may be stored in the memory 12 or may be held in advance in the communication strength determination unit 114. The communication strength determination unit 114 sends, to the communication route switching unit 118, at least one determination result of whether the communication strength from the communication strength acquisition unit 111 is equal to or greater than the first threshold and whether the communication strength is less than the second threshold.

A communication speed of the cellular communication between the base station/management server 20 and the in-vehicle device 30 is higher than a communication speed of the V2V communication between the in-vehicle devices 30. Therefore, the communication strength when a maximum speed value of the V2V communication is obtained can be adopted as the first threshold indicating whether the communication strength of the cellular communication is “good”.

Further, the grid computing management device 10 may use a future prediction value (for example, after several seconds) calculated based on a communication strength at a current time point for determination of the communication strength of the cellular communication between the base station/management server 20 and the in-vehicle device 30. That is, the grid computing management device 10 may determine that the communication strength of the cellular communication between the base station/management server 20 and the in-vehicle device 30 is “good” when the grid computing management device 10 determines that a calculation result of the prediction value is equal to or greater than the first threshold.

The in-vehicle device information management unit 115 temporarily holds and manages the data of the in-vehicle device information from the in-vehicle device information acquisition unit 112. The in-vehicle device information management unit 115 sends the data of the in-vehicle device information from the in-vehicle device information acquisition unit 112 to the communication route switching unit 118. The in-vehicle device information management unit 115 may be implemented by the processor 11, or may be implemented by a memory device such as a RAM.

The data traffic determination unit 116 acquires the data of the data traffic from the data traffic acquisition unit 113, and determines whether the data traffic is less than a predetermined upper limit value. The upper limit value is an upper limit value of a data traffic predetermined based on specification or performance of the base station/management server 20, a frequency band used in the network NW1, and the like. The upper limit value may be stored in the memory 12 or may be held in advance in the data traffic determination unit 116.

The processing request content management unit 117 receives and acquires data indicating request contents of processing to be executed in the grid computing system 100 allocated by the base station/management server 20, via the base station/management server 20 and the communication interface 13. The processing request content management unit 117 temporarily holds and manages the data of request contents from the base station/management server 20 or sends the data to the communication route switching unit 118. The processing request content management unit 117 may be implemented by the processor 11, or may be implemented by a memory device such as a RAM.

Here, the processing program and the processing data will be described.

### [Processing Program]

In the present embodiment, the processing program is a program that is commonly used by any in-vehicle device regardless of being executed by any in-vehicle device among the plurality of in-vehicle devices 30 that constitute the grid computing system 100. In other words, each of the plurality of in-vehicle devices 30 uses the same processing program when processing to be executed in the grid computing system 100 is performed. Therefore, when the in-vehicle device of the vehicle C1 does not hold the processing program, the in-vehicle device may use a processing program sent from the base station/management server 20 through cellular communication or may use a processing program sent from an in-vehicle device of another vehicle (for example, vehicle C2) through V2V communication.

### [Processing Data]

On the other hand, the processing data is data unique to each in-vehicle device 30 that performs processing to be executed in the grid computing system 100. Therefore, when the in-vehicle device of the vehicle C1 does not hold processing data necessary for processing to be executed by the in-vehicle device of the vehicle C1, the in-vehicle device needs to acquire processing data, which is unique data that can be used only by the in-vehicle device, through cellular communication from the base station/management server 20 or through V2V communication from an in-vehicle device of another vehicle (for example, vehicle C2). The in-vehicle device 30 may hold not only processing data used by the in-vehicle device 30 to execute processing, but also processing data used by another in-vehicle device (that is, another in-vehicle device 30a) to execute processing. Depending on the communication status, the in-vehicle device 30 transmits the processing data to another in-vehicle device through V2V communication.

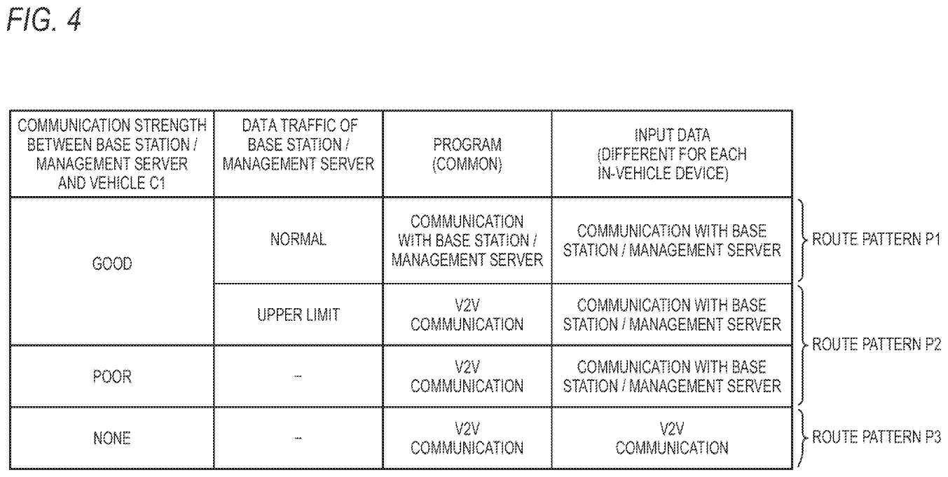

The communication route switching unit 118 receives and acquires the determination result of the communication strength from the communication strength determination unit 114, a determination result of the data traffic from the data traffic determination unit 116, and the data of the request contents from the processing request content management unit 117. The communication route switching unit 118 switches a transmission route (in other words, transfer route) for the processing program and the processing data to the in-vehicle device 30 based on the determination result of the communication strength between the base station/management server 20 and the in-vehicle device 30 and the determination result of the data traffic. Further, the communication route switching unit 118 may switch the transmission route for the processing program and the processing data to the in-vehicle device 30 in consideration of not only the determination result of the communication strength between the base station/management server 20 and the in-vehicle device 30 and the determination result of the data traffic but also the data of the request contents. The communication route switching unit 118 may maintain the current communication route depending on the determination result of the communication strength between the base station/management server 20 and the in-vehicle device 30 and the determination result of the data traffic. Similarly, the communication route switching unit 118 may maintain the current communication route depending on the determination result of the communication strength between the base station/management server 20 and the in-vehicle device 30, the determination result of the data traffic, and the data of the request contents. The communication route switching unit 118 sends, to the data transmission control unit 119, data indicating the switched or current transmission route for the processing program and the processing data. When the transmission route is maintained, the communication route switching unit 118 may omit the processing of sending the data indicating the transmission route to the data transmission control unit 119. An example of switching will be described later with reference to FIG. 4.

The data transmission control unit 119 sets a transmission route corresponding to each of the processing program and the processing data based on the data indicating the transmission route from the communication route switching unit 118. The data transmission control unit 119 sends data indicating the set transmission route to the communication interface 13. According to the transmission route set by the data transmission control unit 119, the communication interface 13 instructs the base station/management server 20 to send each of the processing program and the processing data held by the base station/management server 20 from the base station/management server 20 to the in-vehicle device 30. According to an instruction from the communication interface 13, the base station/management server 20 sends, to the in-vehicle device 30, each of the processing program and the processing data stored in the memory 21 along a transmission route set by the grid computing management device 10.

The memory 12 includes the ROM and the RAM. The ROM stores a program that defines processing (operation) of each unit functionally included in the processor 11, and data that is referenced when the program is executed. The RAM is a work memory used when the processing (operation) of each unit functionally provided in the processor 11 is executed, and temporarily stores data generated or acquired in each processing. The memory 12 temporarily stores, for example, data indicating a transmission route for the processing program and the processing data set by the communication route switching unit 118.

The communication interface 13 is implemented using a communication circuit for performing data communication between the grid computing management device 10 and the base station/management server 20. The communication interface 13 receives various types of data acquired or received by the base station/management server 20 and sends the data to the processor 11 or stores the data in the memory 12.

The base station/management server 20 includes the memory 21. The memory 21 includes a ROM and a RAM. The ROM stores a program that defines processing (operation) of each unit functionally included in a processor of the base station/management server 20, and data that is referenced when the program is executed. The RAM is a work memory used when the processing (operation) of each unit functionally included in the processor of the base station/management server 20 is executed, and temporarily stores data generated or acquired in each processing. The memory 21 stores a processing program and processing data necessary for executing processing (calculation processing) to be performed in grid computing. The memory 21 stores processing data unique to each in-vehicle device 30.

### 3. Detailed Configuration Example of In-Vehicle Terminal

Next, a configuration example of the in-vehicle device 30 according to the present embodiment will be described with reference to FIG. 3. FIG. 3 is a block diagram illustrating a hardware configuration example of the in-vehicle device 30.

The in-vehicle devices 30 are commonly mounted on respective vehicles (for example, vehicles C1, C2, C3, E1, and E2 in FIG. 1), and acquire in-vehicle device information such as the movement direction and the speed of the mounted vehicle (see the above description). The in-vehicle device 30 can perform V2V communication with another in-vehicle device 30a mounted on another vehicle traveling in the same movement direction, and can also perform cellular communication with the base station/management server 20.

The in-vehicle device 30 illustrated in FIG. 3 at least includes a data storage unit 31, a cellular communication unit 32, a V2V communication unit 33, a communication strength acquisition unit 34, an in-vehicle device information acquisition unit 35, and a data processing unit 36. Although the in-vehicle device 30 and the another in-vehicle device 30a have the same configuration, different reference numerals are used to clarify that the in-vehicle device 30 is mounted on the own vehicle (for example, vehicle C1) and the another in-vehicle device 30a is mounted on another vehicle (for example, vehicle C2) different from the own vehicle.

The data storage unit 31 is implemented by, for example, a semi-conductor memory such as a flash memory, and temporarily stores data generated or acquired by each unit of the in-vehicle device 30. For example, the data storage unit 31 stores a processing program and processing data sent from the base station/management server 20. The data storage unit 31 may store processing data necessary for processing to be executed by the another in-vehicle device 30a mounted on another vehicle (for example, vehicle C2) different from the own vehicle (for example, vehicle C1) on which the in-vehicle device 30 is mounted.

The cellular communication unit 32 is implemented by a communication circuit capable of performing cellular communication, and performs cellular communication with the base station/management server 20. When the communication status between the in-vehicle device 30 and the base station/management server 20 is “good” (described later with reference to FIG. 4), the cellular communication unit 32 can transmit, for example, data of a processing result by the data processing unit 36, the data of the in-vehicle device information, and the data of the communication strength to the base station/management server 20 through cellular communication. Further, when the communication status between the in-vehicle device 30 and the base station/management server 20 is “good” (described later with reference to FIG. 4), the cellular communication unit 32 can receive, for example, the processing data for the in-vehicle device 30 and the processing program from the base station/management server 20 through cellular communication.

The V2V communication unit 33 is implemented by a communication circuit capable of performing V2V communication, and performs V2V communication between the in-vehicle device 30 and the another in-vehicle device 30a mounted on another vehicle (for example, vehicle C2) different from the own vehicle (for example, vehicle C1) on which the in-vehicle device 30 is mounted. When a communication strength between the in-vehicle device 30 and the another in-vehicle device 30a acquired by the communication strength acquisition unit 34 is equal to or greater than a predetermined threshold, the V2V communication unit 33 transmits, for example, at least one of the processing data for the another in-vehicle device 30a and the processing program that are stored in the data storage unit 31 to the another in-vehicle device 30a through V2V communication. Further, when a communication strength between the in-vehicle device 30 and the another in-vehicle device 30a acquired by the communication strength acquisition unit 34 is equal to or greater than the predetermined threshold, the V2V communication unit 33 receives, for example, at least one of the processing data for the in-vehicle device 30 and the processing program from the another in-vehicle device 30a through V2V communication.

The communication strength acquisition unit 34 acquires, from the cellular communication unit 32, a value of a communication strength (for example, reception field strength such as RSSI) when the cellular communication unit 32 receives communication data (for example, bulk data of predetermined digit bits) from the base station/management server 20. The communication strength acquisition unit 34 acquires, from the V2V communication unit 33, a value of a communication strength (for example, reception field strength such as RSSI) when the V2V communication unit 33 receives communication data (for example, bulk data of predetermined digit bits) from the another in-vehicle device 30a. The communication strength is, for example, data of an index indicating good or poor of the communication status between the base station/management server 20 and the in-vehicle device 30 or between the in-vehicle device 30 and the another in-vehicle device 30a. The communication strength acquisition unit 34 sends the data of the communication strength to the in-vehicle device information acquisition unit 35, the cellular communication unit 32, or the V2V communication unit 33.

The in-vehicle device information acquisition unit 35 acquires in-vehicle device information including a processing result of the data processing unit 36 or a processing result of calculation by a control circuit (not illustrated) in the own vehicle (for example, vehicle C1) connected to the in-vehicle device 30. The in-vehicle device information acquisition unit 35 temporarily stores the acquired in-vehicle device information in the data storage unit 31 or sends the acquired in-vehicle device information to the cellular communication unit 32 or the V2V communication unit 33.

The data processing unit 36 executes processing (calculation processing) to be performed in grid computing in the grid computing system 100 by using a processing program and processing data acquired via the grid computing management device 10 or the another in-vehicle device 30a. The data processing unit 36 may execute processing other than processing (calculation processing) to be performed in grid computing. The data processing unit 36 temporarily stores the data of the processing result in the data storage unit 31 or sends the data to the cellular communication unit 32 or the V2V communication unit 33.

### 4. Transmission Route for Processing Program and Processing Data According to Communication Status

Next, a transmission route for the processing program and the processing data according to a communication status determined by the grid computing management device 10 will be described with reference to FIG. 4. FIG. 4 is a table illustrating an example of a switching pattern of the transmission routes for the processing program and the processing data. The route pattern is a pattern of the transmission route for the processing program and the processing data. In the present embodiment, for example, three route patterns P1, P2, and P3 are assumed.

### [Route Pattern P1]

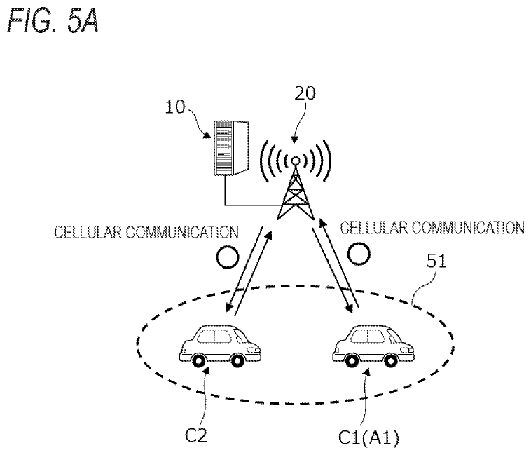

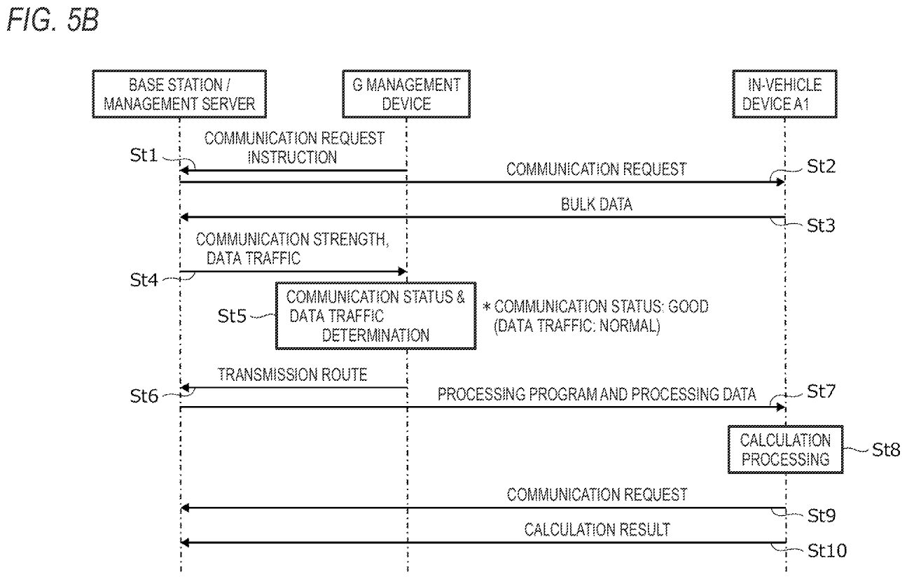

A case is assumed in which a communication strength between the base station/management server 20 and the in-vehicle device of the vehicle C1 is “good” (an example of a first condition, that is, equal to or greater than the first threshold) and the data traffic of the base station/management server 20 is “normal” (in other words, less than the upper limit value). Here, “less than the upper limit value” indicates that it is sufficiently less than the upper limit value. In this case, it is considered that there is no problem in wireless communication (so-called cellular communication) between the base station/management server 20 and the in-vehicle device of the vehicle C1, and the base station/management server 20 is also in a state in which it is possible to sufficiently perform cellular communication. Therefore, the grid computing management device 10 determines and sets a transmission route for the processing program and the processing data as a route pattern P1 in the case described above such that the processing program and the processing data are transmitted from the base station/management server 20 to the in-vehicle device of the vehicle C1 through cellular communication. A processing example of the route pattern P1 will be described later with reference to FIG. 5A and FIG. 5B.

### [Route Pattern P2]

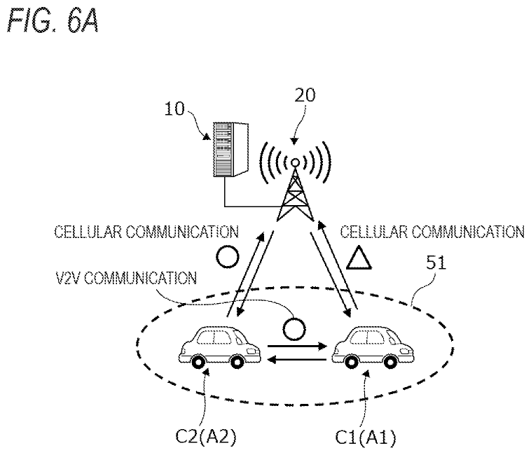

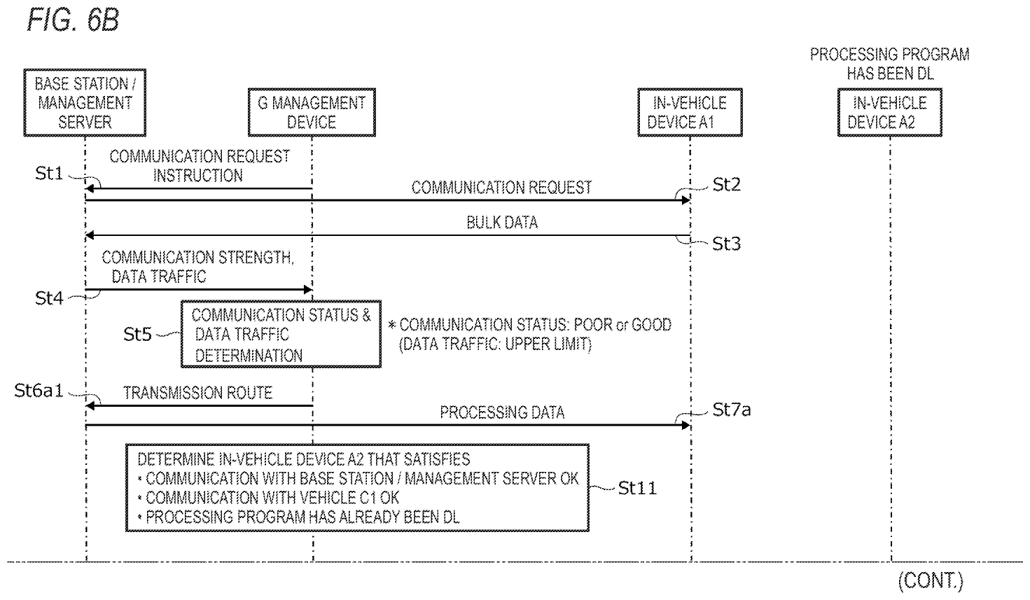

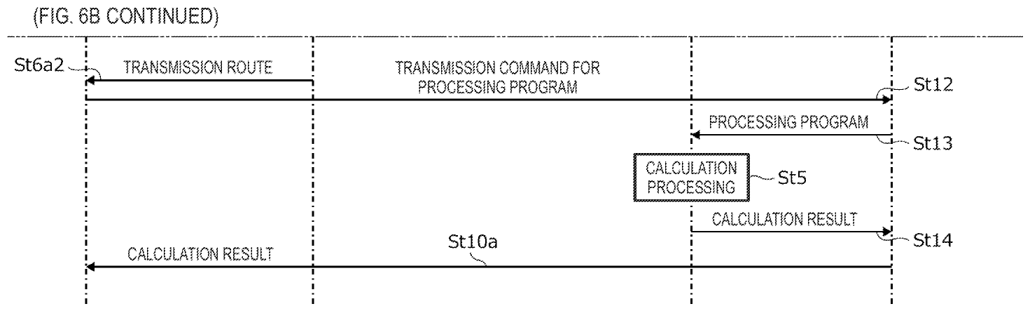

A case is assumed in which the communication strength between the base station/management server 20 and the in-vehicle device of the vehicle C1 is “good” (an example of the first condition, that is, equal to or greater than the first threshold), and the data traffic of the base station/management server 20 is “upper limit” (in other words, a value equal to the upper limit value or a value about 90% of the upper limit value). Further, a case is assumed in which the communication strength between the base station/management server 20 and the in-vehicle device of the vehicle C1 is “poor” (an example of a second condition, that is, less than the first threshold). In these cases, it is possible to perform wireless communication (so-called cellular communication) between the base station/management server 20 and the vehicle C1. However, it is not appropriate to transmit and receive very large amounts of data, which is considered to be an obstacle to achieving grid computing. Therefore, the grid computing management device 10 determines and sets a transmission route for the processing program and the processing data as a route pattern P2 in the cases described above such that only the processing data unique to the in-vehicle device is transmitted from the base station/management server 20 to the in-vehicle device of the vehicle C1 through cellular communication, and the processing program shared by each in-vehicle device is transmitted to the in-vehicle device of the vehicle C1 through V2V communication via another in-vehicle device (for example, in-vehicle device of the vehicle C2). A processing example of the route pattern P2 will be described later with reference to FIG. 6A and FIG. 6B.

### [Route Pattern P3]

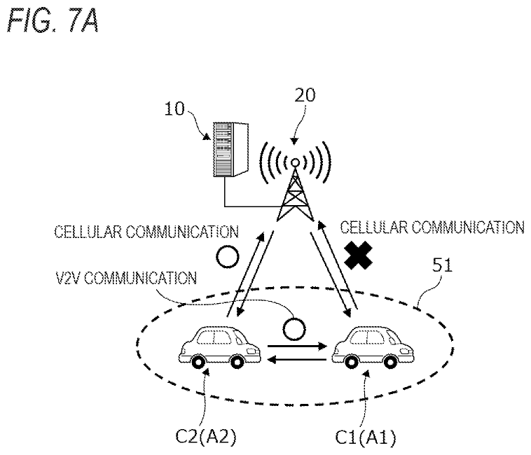

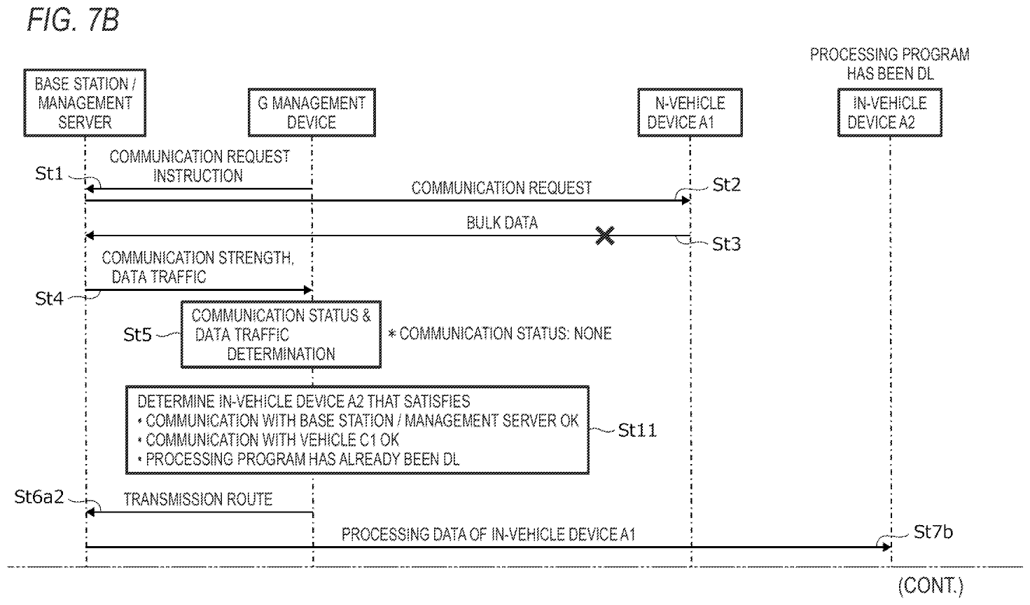

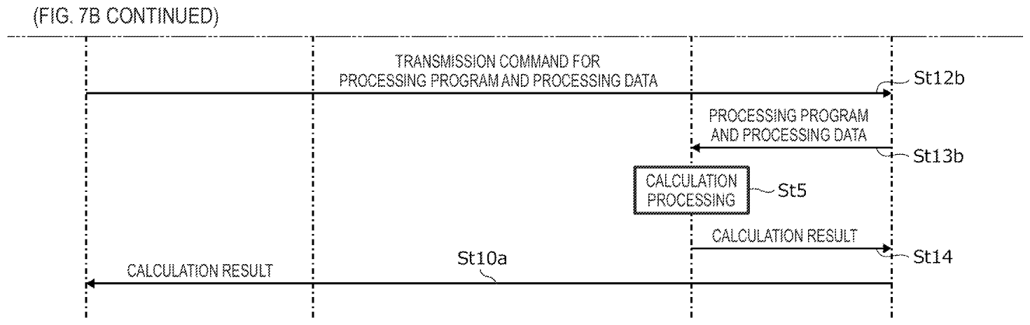

A case is assumed in which the communication strength between the base station/management server 20 and the in-vehicle device of the vehicle C1 is “none” (an example of a third condition, that is, less than the second threshold). In this case, it is considered that wireless communication (so-called cellular communication) between the base station/management server 20 and the vehicle C1 is impossible. Therefore, the grid computing management device 10 determines and sets a transmission route for the processing program and the processing data as a route pattern P3 in the case described above such that the processing program and the processing data are transmitted to the in-vehicle device of the vehicle C1 through V2V communication via another in-vehicle device (for example, in-vehicle device of the vehicle C2). A processing example of the route pattern P3 will be described later with reference to FIG. 7A and FIG. 7B.

In the route pattern P2, when the communication strength between the base station/management server 20 and the in-vehicle device of the vehicle C1 is “poor”, the grid computing management device 10 may determine whether to switch the transmission route (in other words, transfer route) by taking into consideration a current data traffic of the base station/management server 20. For example, when the communication strength between the base station/management server 20 and the in-vehicle device of the vehicle C1 is “poor” and the current data traffic of the base station/management server 20 is “upper limit”, the grid computing management device 10 may determine and set a transmission route for the processing program and the processing data such that the processing program and the processing data are transmitted to the in-vehicle device of the vehicle C1 through V2V communication via another in-vehicle device (for example, in-vehicle device of the vehicle C2), similarly to the route pattern P3. Further, for example, in a case in which the current data traffic is “normal” even when the communication strength between the base station/management server 20 and the in-vehicle device of the vehicle C1 is “poor”, the grid computing management device 10 may determine and set a transmission route for the processing program and the processing data such that the processing program and the processing data are transmitted from the base station/management server 20 to the in-vehicle device of the vehicle C1 through cellular communication, similarly to the route pattern P1.

Further, in a case in which the communication strength between the base station/management server 20 and the in-vehicle device of the vehicle C1 is “poor” in the route pattern P2, the grid computing management device 10 may determine and set a transmission route for the processing program and the processing data so as to switch to the same transmission route as that of the route pattern P3. Specifically, the grid computing management device 10 may determine and set a transmission route for the processing program and the processing data such that the processing program and the processing data are transmitted to the in-vehicle device of the vehicle C1 through V2V communication via another in-vehicle device (for example, in-vehicle device of the vehicle C2).

### 5. Operation Outline and Operation Sequence for Each Route Pattern

Next, with reference to FIG. 5A, FIG. 5B, FIG. 6A, FIG. 6B, FIG. 7A, and FIG. 7B, an operation outline and an operation sequence corresponding to each of the route patterns P1, P2, and P3 in FIG. 4 will be described. FIG. 5A is a diagram illustrating an operation outline example of the route pattern P1. FIG. 5B is a sequence diagram illustrating, in time series, an operation procedure example of the grid computing system 100 according to the route pattern P1. FIG. 6A is a diagram illustrating an operation outline example of the route pattern P2. FIG. 6B is a sequence diagram illustrating, in time series, an operation procedure example of the grid computing system 100 according to the route pattern P2. FIG. 7A is a diagram illustrating an operation outline example of the route pattern P3. FIG. 7B is a sequence diagram illustrating, in time series, an operation procedure example of the grid computing system 100 according to the route pattern P3. In FIG. 5B, FIG. 6B, and FIG. 7B, the grid computing management device is abbreviated as “G management device”.

### 5-1. Route Pattern P1

As illustrated in FIG. 5A, upon describing the operation sequence of the route pattern P1, it is assumed that the base station/management server 20 is successfully performing wireless communication (cellular communication) with each of the in-vehicle devices of the vehicles C1 and C2 forming the vehicle group 51 traveling in the same direction set by the grid computing management device 10 (see FIG. 4). The description in FIG. 5B illustrates an operation sequence among the base station/management server 20, the grid computing management device 10, and an in-vehicle device A1. The in-vehicle device A1 has the same configuration as the in-vehicle device 30 illustrated in FIG. 3, and represents the in-vehicle device of each of the vehicles C1 and C2 illustrated in FIG. 5A.

In FIG. 5B, the grid computing management device 10 generates an instruction (communication request instruction) for transmitting a communication request for performing cellular communication with the in-vehicle device A1 and sends the instruction to the base station/management server 20 (step St1). The base station/management server 20 receives the communication request instruction sent in step St1, generates a communication request based on the communication request instruction, and sends the communication request to the in-vehicle device A1 (step St2). Based on reception of the communication request sent from the base station/management server 20 in step St2, the in-vehicle device A1 transmits predetermined communication data (for example, bulk data of predetermined digit bits) to the base station/management server 20 (step St3).

The base station/management server 20 receives the bulk data sent in step St3, and sends, to the grid computing management device 10, data respectively indicating a communication strength between the base station/management server 20 and the in-vehicle device A1 and a current data traffic of the base station/management server 20 based on the reception (step St4). Based on the data of the communication strength sent in step St4, the grid computing management device 10 determines a communication status (for example, communication strength) between the base station/management server 20 and the in-vehicle device A1 (step St5). Further, based on the data of the data traffic sent in step St4, the grid computing management device 10 determines a current data traffic of the base station/management server 20 (in other words, at the time of step St5) (step St5). Here, the grid computing management device 10 determines that the communication strength (for example, RSSI) is equal to or greater than the first threshold and the communication strength is “good”. In the examples in FIG. 5A and FIG. 5B, the grid computing management device 10 determines that the current data traffic of the base station/management server 20 is “normal” (that is, does not sufficiently reach the upper limit value).

Based on the determination in step St5, the grid computing management device 10 determines and sets a transmission route for both the processing program necessary for the processing to be executed by the in-vehicle device A1 and the processing data for the in-vehicle device A1, and sends data indicating the transmission route to the base station/management server 20 (step St6). Based on the data indicating the transmission route sent in step St6, the base station/management server 20 sends both the processing data for the in-vehicle device A1 and the processing program stored in the memory 21 to the in-vehicle device A1 through cellular communication (step St7). The in-vehicle device A1 executes grid computing processing (calculation processing) using the processing data for the in-vehicle device A1 and the processing program sent from the base station/management server 20 in step St7 (step St8).

The in-vehicle device A1 generates a communication request for performing cellular communication with the base station/management server 20 and sends the communication request to the base station/management server 20 (step St9). It is assumed that the base station/management server 20 receives the communication request sent in step St9 and returns a response (Ack) indicating that the communication request is received. Accordingly, the in-vehicle device A1 can recognize that the communication status with the base station/management server 20 is not interrupted. Based on the reception of the response (Ack), the in-vehicle device A1 sends data of a processing result in step St8 to the base station/management server 20 through cellular communication (step St10).

### 5-2. Route Pattern P2

As illustrated in FIG. 6A, upon describing the operation sequence of the route pattern P2, the base station/management server 20 is able to perform wireless communication (cellular communication) with an in-vehicle device A2 of the vehicle C2 forming the vehicle group 51 traveling in the same direction set by the grid computing management device 10. However, it is assumed that the base station/management server 20 is also able to perform wireless communication (cellular communication) with the in-vehicle device A1 of the vehicle C1 forming the vehicle group 51 set by the grid computing management device 10, but the communication status is not good (see FIG. 4). The in-vehicle device A1 in FIG. 6B is the in-vehicle device of the vehicle C1 in FIG. 6A, and the in-vehicle device A2 in FIG. 6B is the in-vehicle device of the vehicle C2 in FIG. 6A. In the description of processing in FIG. 6B, the same processing as those in FIG. 5B are denoted by the same step numbers, the description thereof will be simplified or omitted, and different contents will be described.

In FIG. 6B, the base station/management server 20 receives the bulk data sent in step St3, and sends, to the grid computing management device 10, data respectively indicating a communication strength between the base station/management server 20 and the in-vehicle device A1 and a current data traffic of the base station/management server 20 based on the reception (step St4). Based on the data of the communication strength sent in step St4, the grid computing management device 10 determines a communication status (for example, communication strength) between the base station/management server 20 and the in-vehicle device A1 (step St5). Further, based on the data of the data traffic sent in step St4, the grid computing management device 10 determines a current data traffic of the base station/management server 20 (in other words, at the time of step St5) (step St5). Here, the grid computing management device 10 determines that the communication strength (for example, RSSI) is less than the first threshold, or the communication strength (for example, RSSI) is equal to or greater than the first threshold, but the current data traffic is “upper limit”.

Based on the determination in step St5, the grid computing management device 10 determines a transmission route for the processing data for the in-vehicle device A1 necessary for processing to be executed by the in-vehicle device A1, and sends data indicating the transmission route to the base station/management server 20 (step St6a1). Based on the data indicating the transmission route sent in step St6al, the base station/management server 20 sends the processing data for the in-vehicle device A1 stored in the memory 21 to the in-vehicle device A1 through cellular communication (step St7a). Further, the grid computing management device 10 selects an in-vehicle device that satisfies all the following conditions (step St11). Specifically, the three conditions are: (1) the communication strength of the cellular communication with the base station/management server 20 is “good” (the communication strength (for example, RSSI) is equal to or greater than the first threshold); (2) the communication strength of the V2V communication with the in-vehicle device A1 is “good” (the communication strength (for example, RSSI) is equal to or greater than the predetermined threshold); and (3) the processing program has already been downloaded from the base station/management server 20. For example, the grid computing management device 10 determines that the in-vehicle device A2 of the vehicle C2 forming the vehicle group 51 satisfies all the three conditions described above (step St11).

Based on the determination in step St11, the grid computing management device 10 determines a transmission route for the processing program necessary for the processing to be executed by the in-vehicle device A1, and sends data indicating the transmission route to the base station/management server 20 (step St6a2). Based on the data indicating the transmission route sent in step St6a2, the base station/management server 20 sends the processing program stored in the memory 21 to the in-vehicle device A2 determined (selected) in step St11 through cellular communication (step St12). According to a command sent from the base station/management server 20 in step St12, the in-vehicle device A2 transmits the processing program to the in-vehicle device A1 through V2V communication (step St13). The in-vehicle device A1 executes grid computing processing (calculation processing) using the processing program sent from the in-vehicle device A2 through V2V communication in step St13 and the processing data for the in-vehicle device A1 sent from the base station/management server 20 through cellular communication in step St7a (step St5).

The in-vehicle device A1 sends data of a processing result in step St5 to the in-vehicle device A2 through V2V communication (step St14). The in-vehicle device A2 sends the data of the processing result sent from the in-vehicle device A1 through V2V communication in step St14 to the base station/management server 20 through cellular communication (step St10a).

### 5-3. Route Pattern P3

As illustrated in FIG. 7A, upon describing the operation sequence of the route pattern P3, the base station/management server 20 is able to perform wireless communication (cellular communication) with the in-vehicle device A2 of the vehicle C2 forming the vehicle group 51 traveling in the same direction set by the grid computing management device 10. However, it is assumed that the base station/management server 20 is unable to perform wireless communication (cellular communication) with the in-vehicle device A1 of the vehicle C1 forming the vehicle group 51 set by the grid computing management device 10 (that is, in a communication interrupted state) (see FIG. 4). The in-vehicle device A1 in FIG. 7B is the in-vehicle device of the vehicle C1 in FIG. 7A, and the in-vehicle device A2 in FIG. 7B is the in-vehicle device of the vehicle C2 in FIG. 7A. In the description of processing in FIG. 7B, the same processing as those in FIG. 5B or FIG. 6B are denoted by the same step numbers, the description will be simplified or omitted, and different contents will be described.

In FIG. 7B, even if the base station/management server 20 transmits a communication request in step St2, the base station/management server 20 cannot receive a response (Ack), nor does the base station/management server 20 receive communication data (for example, bulk data) from the in-vehicle device A1. The base station/management server 20 sends, to the grid computing management device 10, data respectively indicating the communication strength between the base station/management server 20 and the in-vehicle device A1 and the current data traffic of the base station/management server 20 (step St4). Accordingly, the grid computing management device 10 determines that the communication strength of the cellular communication between the base station/management server 20 and the in-vehicle device A1 is “none” and the cellular communication with the in-vehicle device A1 cannot be performed (in other words, in the communication interrupted state) (step St5).

The grid computing management device 10 selects an in-vehicle device that satisfies all the following conditions (step St11). Specifically, the three conditions are: (1) the communication strength of the cellular communication with the base station/management server 20 is “good” (the communication strength (for example, RSSI) is equal to or greater than the first threshold); (2) the communication strength of the V2V communication with the in-vehicle device A1 is “good” (the communication strength (for example, RSSI) is equal to or greater than the predetermined threshold); and (3) the processing program has already been downloaded from the base station/management server 20. For example, the grid computing management device 10 determines that the in-vehicle device A2 of the vehicle C2 forming the vehicle group 51 satisfies all the three conditions described above (step St11).

Based on the determination in step St11, the grid computing management device 10 determines a transmission route for both the processing program necessary for the processing to be executed by the in-vehicle device A1 and the processing data for the in-vehicle device A1, and sends data indicating the transmission route to the base station/management server 20 (step St6a2). Based on the data indicating the transmission route sent in step St6a2, the base station/management server 20 acquires, from the memory 21, processing data for the in-vehicle device A1 necessary for processing to be executed by the in-vehicle device A1, and sends the processing data to the in-vehicle device A2 through cellular communication (step St7b). Subsequently, the base station/management server 20 generates a command (instruction) for transmitting, to the in-vehicle device A1 through V2V communication, both the processing data for the in-vehicle device A1 and the processing program from the in-vehicle device A2 determined (selected) in step St11, and sends the command to the in-vehicle device A2 through cellular communication (step St12b). According to the command sent from the base station/management server 20 in step St12b, the in-vehicle device A2 transmits the processing data for the in-vehicle device A1 and the processing program to the in-vehicle device A1 through V2V communication (step St13b). The in-vehicle device A1 executes grid computing processing (calculation processing) using the processing data for the in-vehicle device A1 and the processing program sent from the in-vehicle device A2 through V2V communication in step St13b (step St5).

The in-vehicle device A1 sends data of a processing result in step St5 to the in-vehicle device A2 through V2V communication (step St14). The in-vehicle device A2 sends the data of the processing result sent from the in-vehicle device A1 through V2V communication in step St14 to the base station/management server 20 through cellular communication (step St10a).

### 6. Operation Procedure of Grid Computing Management Device

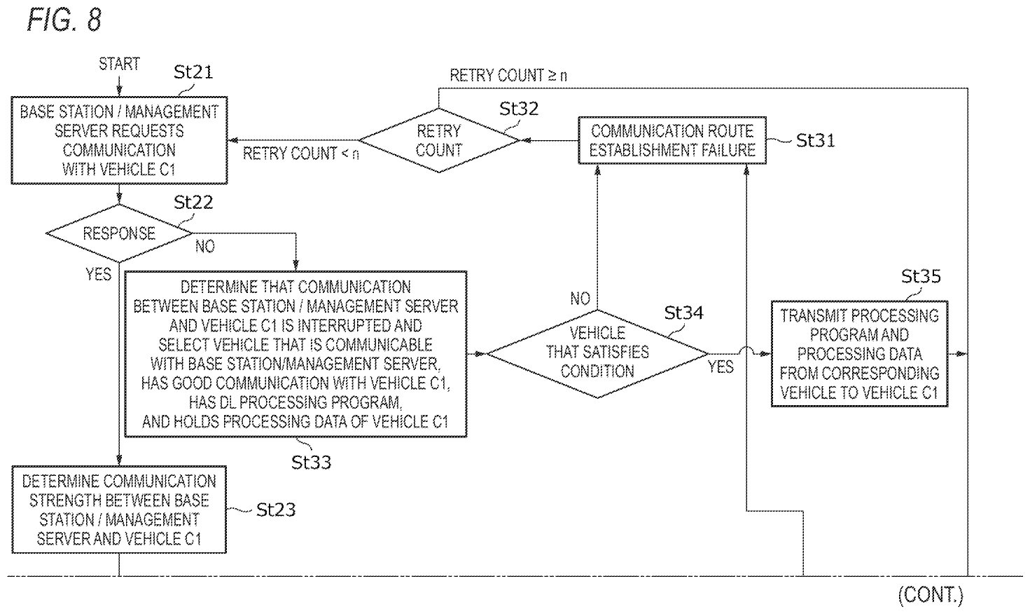

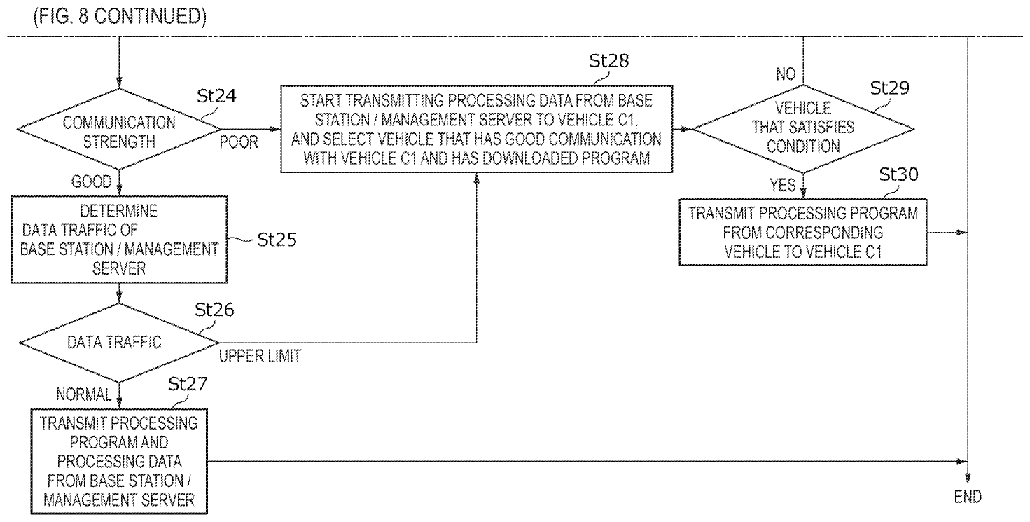

Next, an operation procedure of the grid computing management device 10 according to the present embodiment will be described with reference to FIG. 8. FIG. 8 is a flowchart illustrating, in time series, the operation procedure of the grid computing management device 10. Each processing illustrated in FIG. 8 is mainly executed by the processor 11 of the grid computing management device 10 cooperating with the memory 12.

In FIG. 8, the processor 11 instructs the base station/management server 20 to send a request for wireless connection with one or more in-vehicle devices A1 (for example, in-vehicle device of the vehicle C1 illustrated in FIG. 1) existing within the communicable range of the base station/management server 20 (step St21). In response to receiving this instruction, the base station/management server 20 requests wireless connection with one or more in-vehicle devices A1 (for example, in-vehicle device of the vehicle C1 illustrated in FIG. 1) existing within the communicable range of the base station/management server 20.

It is assumed that the processor 11 acquires a response (Ack) from the in-vehicle device A1 to the request sent in step St21 via the base station/management server 20 (step St22, YES). The processor 11 instructs the base station/management server 20 to establish a wireless connection. In response to receiving this instruction, the base station/management server 20 establishes a wireless connection with the in-vehicle device A1. The processor 11 determines the communication strength between the base station/management server 20 and the in-vehicle device A1 (step St23). When the processor 11 determines that the communication strength determined in step St23 is “good” (step St24, good), the processor 11 determines the current data traffic of the base station/management server 20 (step St25). When the processor 11 determines that the data traffic determined in step St25 is “normal” (step St26, normal), the processor 11 switches to the route pattern P1 (see FIG. 4) or maintains setting of the route pattern P1 (see FIG. 4). Based on the route pattern P1, the processor 11 instructs the base station/management server 20 to send both the processing data for the in-vehicle device A1 and the processing program from the base station/management server 20 to the in-vehicle device 30 through cellular communication based on the wireless connection established in step St22 (step St27). In response to receiving this instruction, the base station/management server 20 sends both the processing data for the in-vehicle device A1 and the processing program stored in the memory 21 to the in-vehicle device A1 through cellular communication. After step St27, the processing of the processor 11 illustrated in FIG. 8 ends.

On the other hand, when the processor 11 determines that the communication strength determined in step St23 is “poor” (step St24, poor) or when the processor 11 determines that the data traffic determined in step St25 is “upper limit” (step St26, upper limit), the processor 11 switches to the route pattern P2 (see FIG. 4) or maintains setting of the route pattern P2 (see FIG. 4). Based on the route pattern P2 (see FIG. 4), the processor 11 instructs the base station/management server 20 to send the processing data for the in-vehicle device A1 from the base station/management server 20 to the in-vehicle device A1 through cellular communication based on the wireless connection established in step St22 (step St28). In response to receiving this instruction, the base station/management server 20 sends the processing data for the in-vehicle device A1 stored in the memory 21 to the in-vehicle device A1 through cellular communication. Further, the processor 11 selects an in-vehicle device (for example, in-vehicle device A2 of the vehicle C2) that satisfies a condition that the communication strength with the in-vehicle device A1 of the vehicle C1 is “good”, the communication strength of the V2V communication with the in-vehicle device A1 is equal to or greater than the predetermined threshold, and the processing program has been downloaded (step St28). When the processor 11 determines that there is an in-vehicle device A2 that satisfies the condition in step St28 (step St29, YES), the processor 11 instructs the base station/management server 20 to send, to the in-vehicle device A2 selected in step St28, a command for sending the processing program to the in-vehicle device A1 through V2V communication (step St30). In response to receiving this instruction, the base station/management server 20 sends, to the in-vehicle device A2 through cellular communication, the command for sending the processing program to the in-vehicle device A1. Based on this command, the in-vehicle device A2 sends the processing program held by the in-vehicle device A2 to the in-vehicle device A1 through V2V communication.

When the processor 11 determines that there is no in-vehicle device that satisfies the condition in step St28 (step St29, NO), the processor 11 determines that establishment of the communication route has failed (step St31). Based on failure determined in step St31, when the processor 11 determines that the number of attempts to establish the communication route (retry count) is less than a predetermined value n (step St32, retry count<n), the processor 11 performs the processing in step St21 and repeats the processing of establishing the communication route. On the other hand, based on the failure determined in step St31, when the processor 11 determines that the number of attempts to establish the communication route (retry count) is equal to or greater than the predetermined value n (step St32, retry count≥ n), the processor 11 stops the processing of establishing the communication route and ends the processing of the processor 11 illustrated in FIG. 8. In this case, for example, the processor 11 may start the processing from step St21 onward after a certain period of time has elapsed.

When the response (Ack) from the in-vehicle device A1 to the request sent in step St21 cannot be acquired via the base station/management server 20 (step St22, NO), the processor 11 determines that the communication between the base station/management server 20 and the in-vehicle device A1 is interrupted (step St33). Further, the processor 11 selects an in-vehicle device (for example, in-vehicle device A2 of the vehicle C2) that satisfies the condition that the communication strength with the in-vehicle device A1 of the vehicle C1 is “good”, the communication strength of the V2V communication with the in-vehicle device A1 is equal to or greater than the predetermined threshold, the processing program has been downloaded, and the processing data for the in-vehicle device A1 is held (step St33). When the processor 11 determines that there is an in-vehicle device A2 that satisfies the condition in step St33 (step St34, YES), the processor 11 instructs the base station/management server 20 to send, to the in-vehicle device A2 selected in step St33, a command for sending the processing data for the in-vehicle device A1 and the processing program to the in-vehicle device A1 through V2V communication (step St35). In response to receiving this instruction, the base station/management server 20 sends, to the in-vehicle device A2 through cellular communication, the command for sending both the processing data for the in-vehicle device A1 and the processing program to the in-vehicle device A1. Based on this command, the in-vehicle device A2 sends both the processing data for the in-vehicle device A1 and the processing program held by the in-vehicle device A2 to the in-vehicle device A1 through V2V communication. After step St35, the processing of the processor 11 illustrated in FIG. 8 ends.

On the other hand, when the processor 11 determines that there is no in-vehicle device that satisfies the condition in step St34 (step St34, NO), the processor 11 determines that the establishment of the communication route has failed (step St31). Since the subsequent processing is as described above, the description thereof is omitted.

### Modification of Embodiment 1

In the grid computing system 100 according to Embodiment 1, the grid computing management device 10 is placed and disposed at the location where the base station/management server 20 is provided. That is, the grid computing management device 10 is not assumed to move. In a grid computing system 100A according to a modification of Embodiment 1, an example in which a grid computing management device is provided in a mobile object (for example, vehicle) will be described.

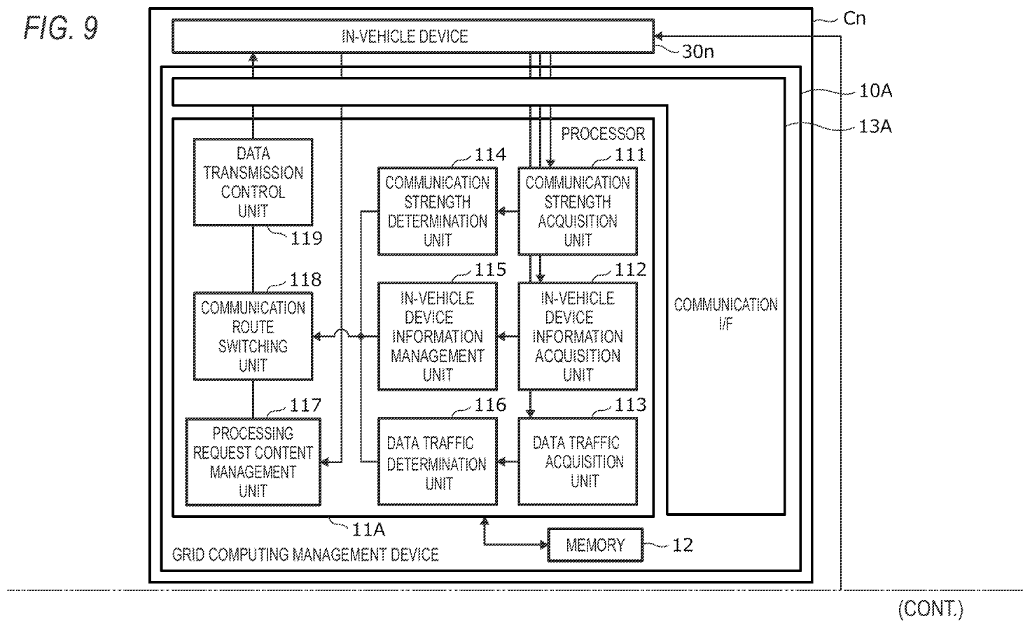

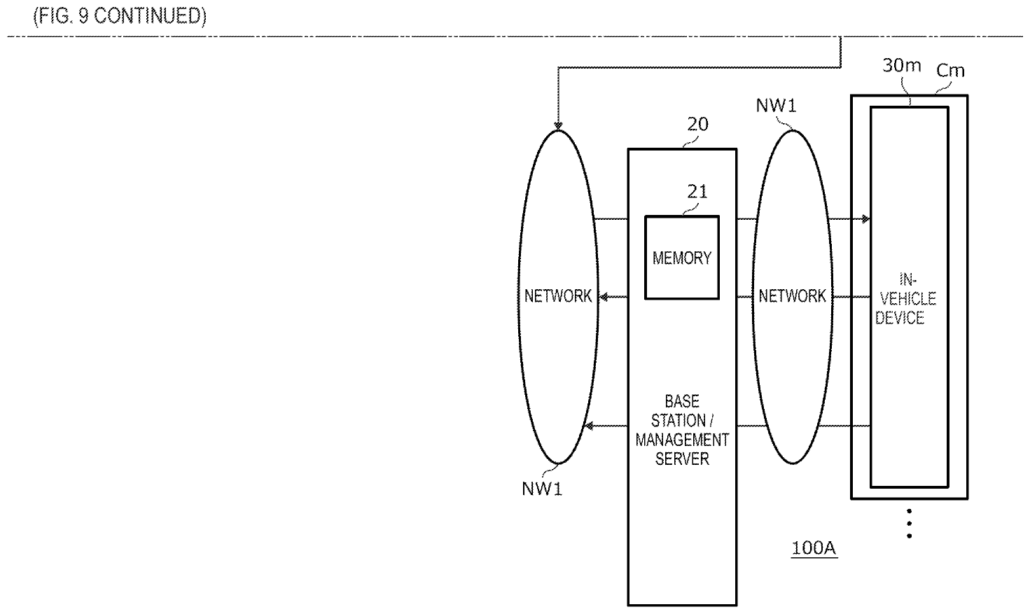

In the grid computing system 100A, an in-vehicle device provided in each of a plurality of mobile objects, a grid computing management device 10A, and the base station/management server 20 cooperate to form a grid computing system. The grid computing system 100A includes the grid computing management device 10A, the base station/management server 20, and a plurality of in-vehicle devices 30n and 30m (see FIG. 9). The grid computing management device 10A and one in-vehicle device 30n are disposed in one vehicle Cn (see FIG. 9).

### 7. Detailed Configuration Example of Grid Computing Management Device

First, a configuration example of the grid computing management device 10A according to the modification of Embodiment 1 will be described with reference to FIG. 9. FIG. 9 is a block diagram illustrating a hardware configuration example of the grid computing management device 10A according to the modification of Embodiment 1. In the description of the grid computing management device 10A, the same components as those illustrated in FIG. 2 are denoted by the same reference numerals, and the description thereof will be simplified or omitted, and different contents will be described.

As illustrated in FIG. 9, one vehicle Cn is provided with the grid computing management device 10A and the in-vehicle device 30n. Further, each of one or more vehicles Cm other than the vehicle Cn is provided with one in-vehicle device 30m. Since configurations of each of the in-vehicle devices 30n and 30m are the same as that of the in-vehicle device 30 illustrated in FIG. 3, the description thereof will be omitted. The base station/management server 20 and the in-vehicle device 30m are wirelessly communicably connected to each other via the network NW1, as in Embodiment 1. In FIG. 9, the number of combinations of the in-vehicle device 30m and the vehicle Cm may be two or more.

The grid computing management device 10A at least includes a processor 11A, a memory 12, and a communication interface 13A. In FIG. 9, the interface is abbreviated as “I/F”. Unlike Embodiment 1, the grid computing management device 10A moves as the vehicle Cn travels. Therefore, in the modification of Embodiment 1, the in-vehicle device 30n of the vehicle Cn is wirelessly communicably connected to the base station/management server 20 via the network NW1.

The communication strength acquisition unit 111 receives and acquires a value of a communication strength (for example, reception field strength such as RSSI) when the in-vehicle device 30n receives communication data (for example, bulk data of predetermined digit bits) from the base station/management server 20, via the in-vehicle device 30n and the communication interface 13A.

The in-vehicle device information acquisition unit 112 acquires data of in-vehicle device information from the in-vehicle device 30n via the communication interface 13A, and receives and acquires data of in-vehicle device information from another in-vehicle device 30m via the base station/management server 20, the in-vehicle device 30n, and the communication interface 13A.

The data traffic acquisition unit 113 receives and acquires data of a data traffic of the in-vehicle device 30n via the communication interface 13A.

The processing request content management unit 117 receives and acquires data indicating request contents of processing to be executed in the grid computing system 100A allocated by the base station/management server 20, via the base station/management server 20, the in-vehicle device 30n, and the communication interface 13.

The data transmission control unit 119 of the processor 11A inputs and outputs data from and to the in-vehicle device 30n. The data input and output here corresponds to, for example, data indicating the transmission route for the processing program and the processing data determined by the communication route switching unit 118. However, the data is not limited thereto.

### 8. Operation Outline and Operation Sequence for Each Route Pattern

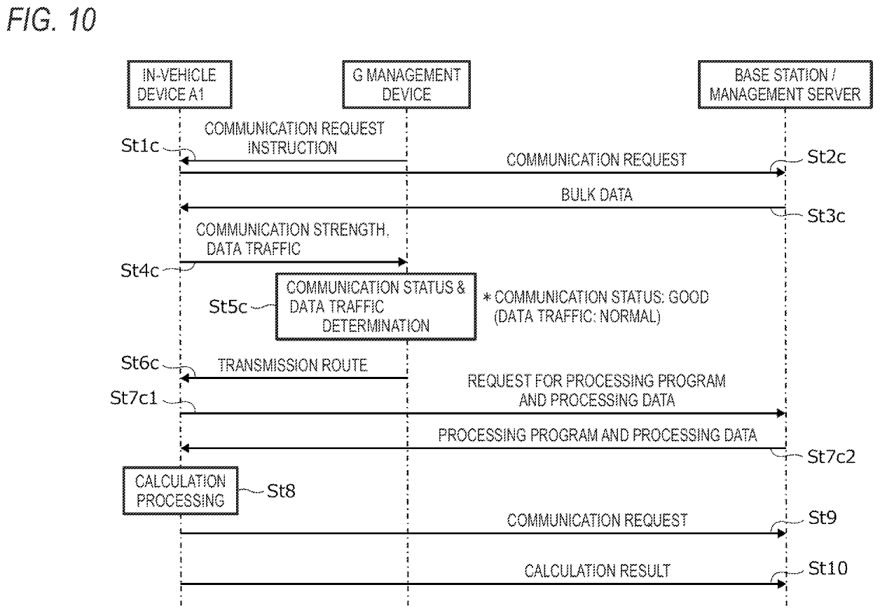

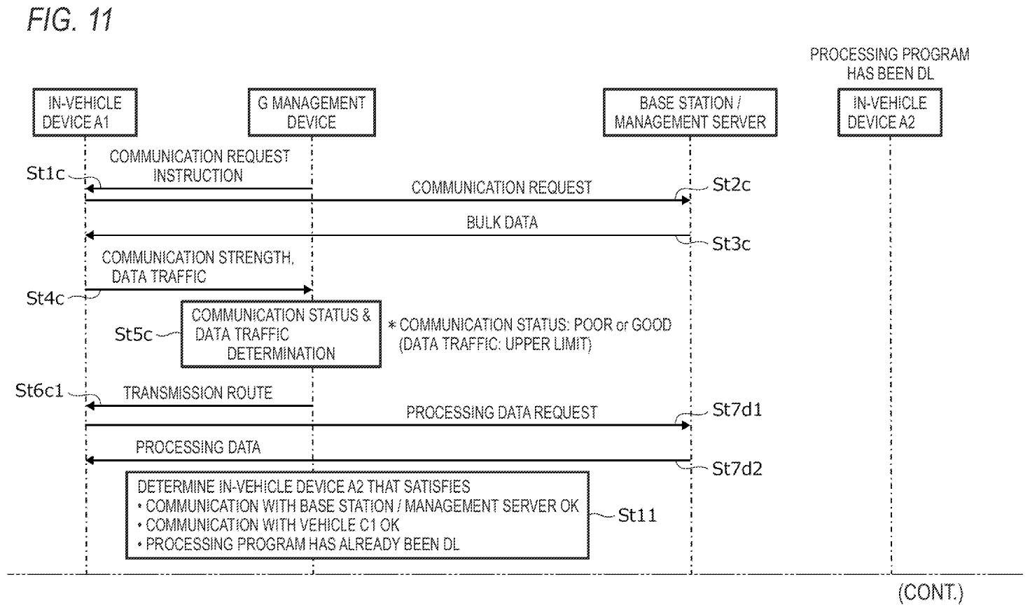

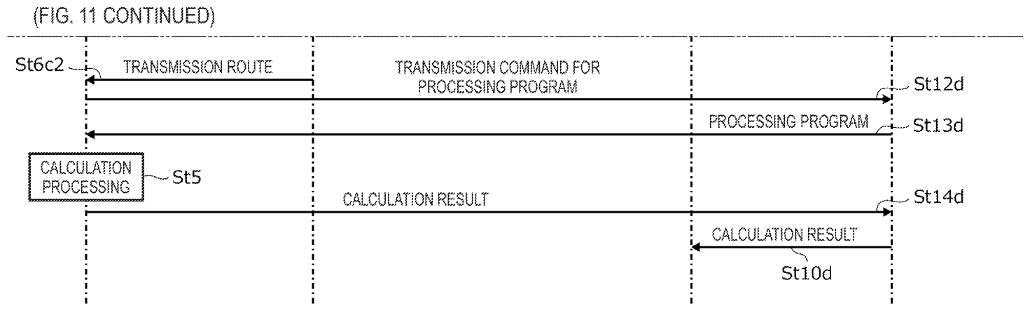

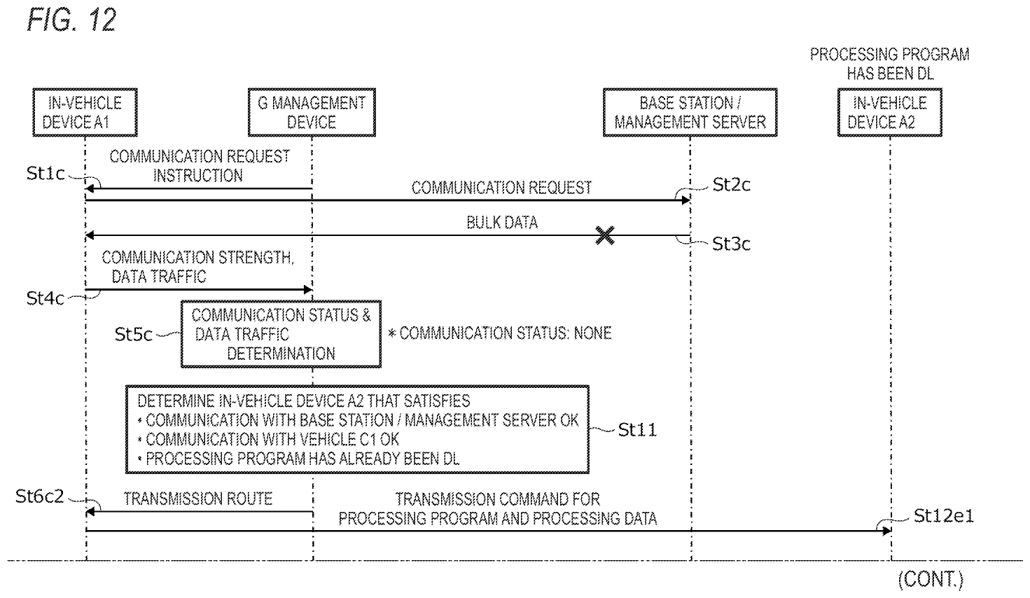

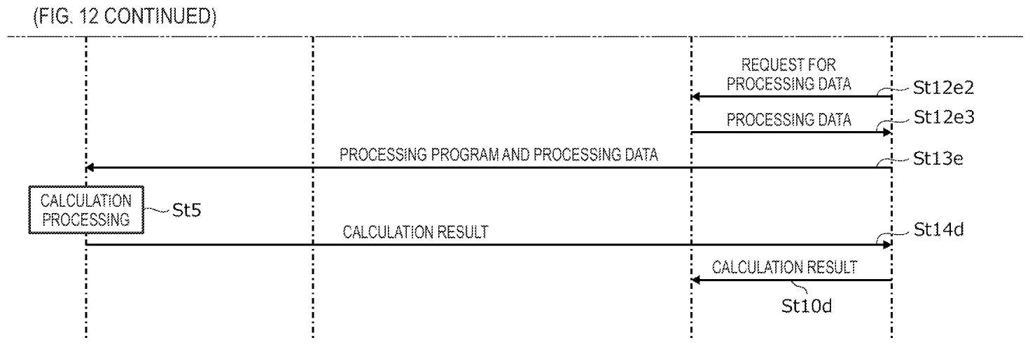

Next, operation sequences according to route patterns P1, P2, and P3 according to the modification of Embodiment 1 will be described with reference to FIG. 10, FIG. 11, and FIG. 12. FIG. 10 is a sequence diagram illustrating, in time series, an operation procedure example of the grid computing system 100A according to the route pattern P1 according to the modification of Embodiment 1. FIG. 11 is a sequence diagram illustrating, in time series, an operation procedure example of the grid computing system 100A according to the route pattern P2 according to the modification of Embodiment 1. FIG. 12 is a sequence diagram illustrating, in time series, an operation procedure example of the grid computing system 100A according to the route pattern P3 according to the modification of Embodiment 1. In the description of processing in FIG. 10, the same processing as those in FIG. 5B are denoted by the same step numbers, the description thereof will be simplified or omitted, and different contents will be described. Further, in the descriptions in FIG. 10 to FIG. 12, the in-vehicle device A1 is the same as the in-vehicle device 30n mounted on the vehicle Cn (see FIG. 9) in which the grid computing management device 10A is disposed. In FIG. 10, FIG. 11, and FIG. 12, the grid computing management device is abbreviated as “G management device”.

### 8-1. Route Pattern P1

Upon describing the operation sequence of the route pattern P1, it is assumed that the base station/management server 20 is successfully performing wireless communication (cellular communication) with the vehicle (in-vehicle device A1) forming the vehicle group 51 traveling in the same direction set by the grid computing management device 10A (see FIG. 4). The description in FIG. 10 illustrates an operation sequence among the in-vehicle device A1, the grid computing management device 10A, and the base station/management server 20. The in-vehicle device A1 corresponds to the in-vehicle device 30n in FIG. 9 and has the same configuration as the in-vehicle device 30 illustrated in FIG. 3.

In FIG. 10, the grid computing management device 10A generates an instruction (communication request instruction) for transmitting a communication request for performing cellular communication with the base station/management server 20 and sends the instruction to the in-vehicle device A1 (step Stlc). The in-vehicle device A1 receives the communication request instruction sent in step Stlc, generates a communication request based on the communication request instruction, and sends the communication request to the base station/management server 20 (step St2c). Based on reception of the communication request sent from the in-vehicle device A1 in step St2c, the base station/management server 20 transmits predetermined communication data (for example, bulk data of predetermined digit bits) to the in-vehicle device A1 (step St3c).

The in-vehicle device A1 receives the bulk data sent in step St3c, and sends, to the grid computing management device 10A, data respectively indicating a communication strength between the base station/management server 20 and the in-vehicle device A1 and a current data traffic of the in-vehicle device A1 based on the reception (step St4c). Based on the data of the communication strength sent in step St4c, the grid computing management device 10A determines a communication status (for example, communication strength) between the base station/management server 20 and the in-vehicle device A1 (step St5c). Further, based on the data of the data traffic sent in step St4c, the grid computing management device 10A determines a current data traffic of the in-vehicle device A1 (in other words, at the time of step St5c) (step St5c). Here, the grid computing management device 10A determines that the communication strength (for example, RSSI) is equal to or greater than the first threshold and the communication strength is “good”. In the example in FIG. 10, the grid computing management device 10A determines that the current data traffic is “normal” (that is, does not sufficiently reach the upper limit value).

Based on the determination in step St5c, the grid computing management device 10A determines a transmission route for both the processing program necessary for the processing to be executed by the in-vehicle device A1 and the processing data for the in-vehicle device A1, and sends data indicating the transmission route to the in-vehicle device A1 (step St6c). Based on the data indicating the transmission route sent in step St6c, the in-vehicle device A1 requests the base station/management server 20 to send both the processing program and the processing data for the in-vehicle device A1 stored in the memory 21 of the base station/management server 20 to the in-vehicle device A1 through cellular communication (step St7cl). Based on the request received in step St7cl, the base station/management server 20 sends both the processing data for the in-vehicle device A1 and the processing program stored in the memory 21 to the in-vehicle device A1 through cellular communication (step St7c2). The in-vehicle device A1 executes grid computing processing (calculation processing) using the processing data for the in-vehicle device A1 and the processing program sent from the base station/management server 20 in step St7c2 (step St8).

The in-vehicle device A1 generates a communication request for performing cellular communication with the base station/management server 20 and sends the communication request to the base station/management server 20 (step St9). It is assumed that the base station/management server 20 receives the communication request sent in step St9 and returns a response (Ack) indicating that the communication request is received. Accordingly, the in-vehicle device A1 can recognize that the communication status with the base station/management server 20 is not interrupted. Based on the reception of the response (Ack), the in-vehicle device A1 sends data of a processing result in step St8 to the base station/management server 20 through cellular communication (step St10).

### 8-2. Route Pattern P2

Upon describing the operation sequence of the route pattern P2, the base station/management server 20 is able to perform wireless communication (cellular communication) with the vehicle (in-vehicle device A2) forming the vehicle group 51 traveling in the same direction set by the grid computing management device 10A. However, it is assumed that the base station/management server 20 performs wireless communication (cellular communication) with the vehicle (in-vehicle device A1) forming the vehicle group 51 set by the grid computing management device 10A, but the communication status is not good (see FIG. 4). In the description of processing in FIG. 11, the same processing as those in FIG. 5B or FIG. 10 are denoted by the same step numbers, the description will be simplified or omitted, and different contents will be described.

In FIG. 11, the in-vehicle device A1 receives the bulk data sent in step St3c, and sends, to the grid computing management device 10A, data respectively indicating the communication strength between the base station/management server 20 and the in-vehicle device A1 and the current data traffic of the in-vehicle device A1 based on the reception (step St4c). Based on the data of the communication strength sent in step St4c, the grid computing management device 10A determines a communication status (for example, communication strength) between the base station/management server 20 and the in-vehicle device A1 (step St5c). Further, based on the data of the data traffic sent in step St4c, the grid computing management device 10A determines a current data traffic of the base station/management server 20 (in other words, at the time of step St5c) (step St5c). Here, the grid computing management device 10A determines that the communication strength (for example, RSSI) is less than the first threshold, or the communication strength (for example, RSSI) is equal to or greater than the first threshold, but the current data traffic is “upper limit”.

Based on the determination in step St5c, the grid computing management device 10A determines a transmission route for processing data for the in-vehicle device A1 necessary for processing to be executed by the in-vehicle device A1, and sends data indicating the transmission route to the in-vehicle device A1 (step St6c1). Based on the data indicating the transmission route sent in step St6cl, the in-vehicle device A1 instructs (requests) the base station/management server 20 to transmit the processing data for the in-vehicle device A1 stored in the memory 21 of the base station/management server 20 to the in-vehicle device A1 through cellular communication (step St7d1). In response to receiving this instruction, the base station/management server 20 sends the processing data for the in-vehicle device A1 stored in the memory 21 to the in-vehicle device A1 through cellular communication (step St7d2). Further, the grid computing management device 10A selects an in-vehicle device that satisfies all the following conditions (step St11). Specifically, the three conditions are: (1) the communication strength of the cellular communication with the base station/management server 20 is “good” (the communication strength (for example, RSSI) is equal to or greater than the first threshold); (2) the communication strength of the V2V communication with the in-vehicle device A1 is “good” (the communication strength (for example, RSSI) is equal to or greater than the predetermined threshold); and (3) the processing program has already been downloaded from the base station/management server 20. For example, the grid computing management device 10A determines that the in-vehicle device A2 of the vehicle C2 forming the vehicle group 51 satisfies all the three conditions described above (step St11).

Based on the determination in step St11, the grid computing management device 10A determines a transmission route for the processing program necessary for processing to be executed by the in-vehicle device A1, and sends data indicating the transmission route to the in-vehicle device A1 (step St6c2). Based on the data indicating the transmission route sent in step St6c2, the in-vehicle device A1 sends, to the in-vehicle device A2 through V2V communication, a command for sending the already downloaded processing program to the in-vehicle device A1 (step St12d). According to the command sent from the in-vehicle device A1 in step St12d, the in-vehicle device A2 transmits the processing program to the in-vehicle device A1 through V2V communication (step St13d). The in-vehicle device A1 executes grid computing processing (calculation processing) using the processing program sent from the in-vehicle device A2 through V2V communication in step St13d and the processing data for the in-vehicle device A1 sent from the base station/management server 20 through cellular communication in step St7d2 (step St5).

The in-vehicle device A1 sends data of a processing result in step St5 to the in-vehicle device A2 through V2V communication (step St14d). The in-vehicle device A2 sends the data of the processing result sent from the in-vehicle device A1 through V2V communication in step St14d to the base station/management server 20 through cellular communication (step St10d).

### 8-3. Route Pattern P3

Upon describing the operation sequence of the route pattern P3, the base station/management server 20 is able to perform wireless communication (cellular communication) with the vehicle (in-vehicle device A2) forming the vehicle group 51 traveling in the same direction set by the grid computing management device 10A. However, it is assumed that the base station/management server 20 is unable to perform wireless communication (cellular communication) with the vehicle (the in-vehicle device A1) forming the vehicle group 51 set by the grid computing management device 10A (that is, in a communication interrupted state) (see FIG. 4). In the description of processing in FIG. 12, the same processing as those in FIG. 5B, FIG. 6B, FIG. 10, or FIG. 11 are denoted by the same step numbers, the description thereof will be simplified or omitted, and different contents will be described.

In FIG. 12, even if the in-vehicle device A1 transmits the communication request in step St2c, the in-vehicle device A1 cannot receive the response (Ack), and does not receive the communication data (for example, bulk data) from the base station/management server 20. The in-vehicle device A1 sends, to the grid computing management device 10A, data respectively indicating the communication strength between the base station/management server 20 and the in-vehicle device A1 and the current data traffic of the in-vehicle device A1 (step St4c). Accordingly, the grid computing management device 10A determines that the communication strength of the cellular communication between the base station/management server 20 and the in-vehicle device A1 is “none” and the cellular communication with the base station/management server 20 cannot be performed (in other words, in the communication interrupted state) (step St5c).

The grid computing management device 10A selects an in-vehicle device that satisfies all the following conditions (step St11). Specifically, the three conditions are: (1) the communication strength of the cellular communication with the base station/management server 20 is “good” (the communication strength (for example, RSSI) is equal to or greater than the first threshold); (2) the communication strength of the V2V communication with the in-vehicle device A1 is “good” (the communication strength (for example, RSSI) is equal to or greater than the predetermined threshold); and (3) the processing program has already been downloaded from the base station/management server 20. For example, the grid computing management device 10A determines that the in-vehicle device A2 of the vehicle C2 forming the vehicle group 51 satisfies all the three conditions described above (step St11).

Based on the determination in step St11, the grid computing management device 10A determines a transmission route for both the processing program necessary for the processing to be executed by the in-vehicle device A1 and the processing data for the in-vehicle device A1, and sends data indicating the transmission route to the in-vehicle device A1 (step St6c2). Based on the data indicating the transmission route sent in step St6c2, the in-vehicle device A1 sends, to the in-vehicle device A2 through V2V communication, a command for sending, to the in-vehicle device A1, both the processing program necessary for processing to be executed by the in-vehicle device A1 and the processing data for the in-vehicle device A1 (step St12el). According to the command sent from the in-vehicle device A1 in step St12el, the in-vehicle device A2 requests processing data for the in-vehicle device A1 to the base station/management server 20 through cellular communication (step St12e2). According to the request sent from the in-vehicle device A2 in step St12e2, the base station/management server 20 sends the processing data for the in-vehicle device A1 stored in the memory 21 to the in-vehicle device A2 through cellular communication (step St12e3). The in-vehicle device A2 transmits, to the in-vehicle device A1 through V2V communication, the already downloaded processing program and the processing data for the in-vehicle device A1 sent from the base station/management server 20 in step St12e3 (step St13e). The in-vehicle device A1 executes grid computing processing (calculation processing) using the processing data for the in-vehicle device A1 and the processing program sent from the in-vehicle device A2 through V2V communication in step St13e (step St5).

The in-vehicle device A1 sends data of a processing result in step St5 to the in-vehicle device A2 through V2V communication (step St14d). The in-vehicle device A2 sends the data of the processing result sent from the in-vehicle device A1 through V2V communication in step St14d to the base station/management server 20 through cellular communication (step St10d).

As described above, the present disclosure discloses the following technical ideas.

### <Technique 1>

The grid computing management device (10) including:
the communication interface (13) data-communicably connected with the base station/management server (20) that is capable of data communication with each of the plurality of in-vehicle devices (30) and stores a program (processing program) and data (processing data) necessary for executing grid computing processing by the in-vehicle device; and
the processor (11), in which
the processor (11)
acquires a communication status between a specific in-vehicle device (for example, in-vehicle device A1 of the vehicle C1), which is one of the plurality of in-vehicle devices, and the base station/management server, and
switches a transmission route for at least one of the program and the data based on the communication status, and instructs transmission from the base station/management server to the specific in-vehicle device.

Accordingly, the grid computing management device can adaptively switch the transmission route for data (for example, for at least one of the processing program and the processing data necessary for the processing to be executed by the specific in-vehicle device in the grid computing system 100) according to the communication status with a mobile terminal (for example, in-vehicle device A1 of the vehicle C1) which is a specific in-vehicle device.

### <Technique 2>

The grid computing management device (10) according to technique 1, in which
when the communication status satisfies a first condition indicating a good state (condition of the route pattern P1), the processor (11) instructs direct transmission of the program (processing program) and the data (processing data) from the base station/management server (20) to the specific in-vehicle device (for example, in-vehicle device A1 of the vehicle C1).

Accordingly, when the communication status with the specific in-vehicle device is good, the grid computing management device can directly and quickly transmit both the processing program and the processing data necessary for the processing to be executed by the specific in-vehicle device in the grid computing system through cellular communication, and can cause the in-vehicle device to early execute the processing.

### <Technique 3>

The grid computing management device (10) according to technique 1 or technique 2, in which
the communication status includes a communication strength between the base station/management server (20) and the specific in-vehicle device (for example, in-vehicle device A1 of the vehicle C1) and a data traffic of the base station/management server, and
the processor (11) determines that the communication status satisfies the first condition when the communication strength is equal to or greater than a first threshold and the data traffic is less than an upper limit value.

Accordingly, the grid computing management device can quantitatively evaluate the communication status based on the communication strength between the base station/management server and the specific in-vehicle device and the data traffic of the base station/management server. Therefore, when the grid computing management device has sufficient resources for wireless communication in which the communication strength is equal to or greater than the first threshold and the data traffic is less than the upper limit value, the grid computing management device can directly and quickly transmit the processing program and the processing data to the specific in-vehicle device through cellular communication.

### <Technique 4>

The grid computing management device (10) according to any one of technique 1 to technique 3, in which
when the communication status satisfies a second condition indicating a state in which communication is difficult (condition of the route pattern P2), the processor (11) instructs direct transmission of one of the program (processing program) and the data (processing data) from the base station/management server (20) to the specific in-vehicle device (for example, in-vehicle device A1 of the vehicle C1), and further instructs the base station/management server to transmit the other of the program and the data to the specific in-vehicle device through vehicle-to-vehicle communication (V2V communication) via another in-vehicle device which is an in-vehicle device other than the specific in-vehicle device among the plurality of in-vehicle devices (30) and is an in-vehicle device capable of data communication with both the specific in-vehicle device and the base station/management server (20).

Accordingly, when the communication status with the specific in-vehicle device is communicable but is not good or is almost reaching the upper limit, the grid computing management device can directly and quickly transmit only one of the processing program and the processing data necessary for the processing to be executed by the specific in-vehicle device in the grid computing system to the specific in-vehicle device (for example, in-vehicle device A1 of the vehicle C1) through cellular communication. Further, the grid computing management device can transmit the other of the processing program and the processing data through V2V communication via another in-vehicle device, which operates at a lower speed than the cellular communication. That is, the grid computing management device can distribute the processing program and the processing data and send them to a target specific in-vehicle device (for example, in-vehicle device A1 of the vehicle C1).

### <Technique 5>

The grid computing management device (10) according to any one of technique 1 to technique 4, in which
the communication status includes a communication strength between the base station/management server (20) and the specific in-vehicle device (for example, in-vehicle device A1 of the vehicle C1) and a data traffic of the base station/management server, and
the processor (11) determines that the communication status satisfies a second condition when the communication strength is less than the first threshold or the communication strength is equal to or greater than the first threshold and the data traffic is the upper limit value.

Accordingly, the grid computing management device can quantitatively evaluate the communication status based on the communication strength between the base station/management server and the specific in-vehicle device and the data traffic of the base station/management server. Therefore, when the grid computing management device does not have sufficient resources for wireless communication in which the communication strength is less than the first threshold or the communication strength is equal to or greater than the first threshold and the data traffic is the upper limit value, the grid computing management device can directly and rapidly transmit one of the processing program and the processing data (for example, processing data unique to the specific in-vehicle device) to the specific in-vehicle device through cellular communication. Further, the grid computing management device can send the processing program shared by the in-vehicle devices to a target specific in-vehicle device (for example, in-vehicle device A1 of the vehicle C1) through V2V communication which operates at a lower speed than the cellular communication.

### <Technique 6>

The grid computing management device (10) according to any one of technique 1 to technique 5, in which
when the communication status satisfies a third condition indicating a communication disabled state (condition of the route pattern P3), the processor (11) instructs the base station/management server to transmit the program (processing program) and the data (processing data) to the specific in-vehicle device through vehicle-to-vehicle communication (V2V communication) via another in-vehicle device which is an in-vehicle device other than the specific in-vehicle device among the plurality of in-vehicle devices (30) and is an in-vehicle device capable of data communication with both the specific in-vehicle device (for example, in-vehicle device A1 of the vehicle C1) and the base station/management server (20).

Accordingly, when the communication status with the specific in-vehicle device is not communicable, the grid computing management device can transmit both the processing program and the processing data necessary for the processing to be executed by the specific in-vehicle device in the grid computing system to the specific in-vehicle device (for example, in-vehicle device A1 of the vehicle C1) through V2V communication via another in-vehicle device, which operates at a lower speed than the cellular communication.

### <Technique 7>

The grid computing management device (10) according to any one of technique 1 to technique 6, in which
the communication status at least includes a communication strength between the base station/management server (20) and the specific in-vehicle device (for example, in-vehicle device A1 of the vehicle C1), and
the processor (11) determines that the communication status satisfies the third condition when the communication strength is less than a second threshold.

Accordingly, the grid computing management device can quantitatively evaluate the communication status based on the communication strength between the base station/management server and the specific in-vehicle device. Therefore, when the wireless communication (cellular communication) in which the communication strength is less than the second threshold is impossible, the grid computing management device can send both the processing program and the processing data to a target specific in-vehicle device (for example, in-vehicle device A1 of the vehicle C1) through V2V communication via another in-vehicle device, which operates at a lower speed than the cellular communication.

### <Technique 8>

The grid computing management device (10) according to technique 4 or technique 6, in which
the processor (11) selects, as the another in-vehicle device among the plurality of in-vehicle devices (30), an in-vehicle device which is an in-vehicle device other than the specific in-vehicle device among the plurality of in-vehicle devices, is an in-vehicle device capable of data communication with both the specific in-vehicle device (for example, in-vehicle device A1 of the vehicle C1) and the base station/management server (20), and is mounted on one or more other vehicles (C2) traveling in the same direction as a specific vehicle (C1) on which the specific in-vehicle device is mounted.

Accordingly, when the communication status with the specific in-vehicle device is communicable but is not good or is almost reaching the upper limit, the grid computing management device can safely send the processing program and the processing data to a target specific in-vehicle device of interest (for example, in-vehicle device A1 of the vehicle C1).

### <Technique 9>

The grid computing management device (10) according to technique 1 to technique 8, in which
the processor (11) determines whether switching of the transmission route for at least one of the program and the data is necessary when the communication status is less than a third threshold, and switches the transmission route based on a determination result thereof.

Accordingly, when there is a change such as a significant deterioration in the communication status or a sudden interruption of the communication, the grid computing management device can adaptively switch the transmission route such that the processing program and the processing data can be transmitted to a target specific in-vehicle device (for example, in-vehicle device A1 of the vehicle C1) through an optimum transmission route at that time.

### <Technique 10>

The grid computing management device (10) according to technique 1 to technique 9, in which
the grid computing management device (10) is disposed on a base station (base station/management server 20) side capable of data communication with each of the plurality of in-vehicle devices (30).

Accordingly, the grid computing management device is an immovable fixed station, and can adaptively switch the transmission route for the processing program and the processing data to be executed in the grid computing system according to the communication status between the fixed station and each of the plurality of in-vehicle devices that move.

### <Technique 11>

The grid computing management device (10A) according to technique 1 to technique 9, in which
the grid computing management device (10A) is disposed in a vehicle (Cn) on which any one in-vehicle device (30n) of the plurality of in-vehicle devices (30) is mounted, and the communication interface (13) is capable of data communication with the in-vehicle device disposed in the vehicle.

Accordingly, the grid computing management device is a movable mobile station, and can adaptively switch the transmission route for the processing program and the processing data to be executed in the grid computing system according to a change in a relative communication status between the movable station and each of the plurality of in-vehicle devices that move.

### <Technique 12>

A transmission route switching method executed by the grid computing management device (10), including:
data-communicably connecting to the base station/management server (20) that is capable of data communication with each of the plurality of in-vehicle devices (30) and stores a program and data necessary for executing grid computing processing by the in-vehicle device;
acquiring a communication status between a specific in-vehicle device (A1), which is one of the plurality of in-vehicle devices, and the base station/management server; and
switching a transmission route for at least one of the program and the data based on the communication status and instructing transmission from the base station/management server to the specific in-vehicle device.

Accordingly, the grid computing management device can adaptively switch the transmission route for data (for example, for at least one of the processing program and the processing data necessary for the processing to be executed by the specific in-vehicle device in the grid computing system 100) according to the communication status with a mobile terminal (for example, in-vehicle device A1 of the vehicle C1) which is a specific in-vehicle device.

### <Technique 13>

A computer readable storage medium on which a program is stored. The program causes the grid computing management device (10), which is a computer, to implement
processing of data-communicably connecting to the base station/management server (20) that is capable of data communication with each of the plurality of in-vehicle devices (30) and stores a program and data necessary for executing grid computing processing by the in-vehicle device;
processing of acquiring a communication status between a specific in-vehicle device (A1), which is one of the plurality of in-vehicle devices, and the base station/management server; and
processing of switching a transmission route for at least one of the program and the data based on the communication status, and instructing transmission from the base station/management server to the specific in-vehicle device.

Accordingly, the grid computing management device can adaptively switch the transmission route for data (for example, for at least one of the processing program and the processing data necessary for the processing to be executed by the specific in-vehicle device in the grid computing system 100) according to the communication status with a mobile terminal (for example, in-vehicle device A1 of the vehicle C1) which is a specific in-vehicle device.

Although various embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the various embodiments described above may be combined freely in a range without deviating from the spirit of the invention.

In the embodiment described above, the communication status of the wireless communication may change while the grid computing management devices 10 and 10A transmit at least one of the processing program and the processing data to a target in-vehicle device. Therefore, when at least one of the processing program and the processing data is transmitted, it is preferable that the grid computing management devices 10 and 10A transmit the processing program and the processing data after dividing them into small parts, and manage which divided parts of the processing program and the processing data are to be transmitted. Accordingly, the grid computing management devices 10 and 10A can resume the transmission of the processing program and the processing data from the middle even when the communication status deteriorates and the transmission has to be interrupted.

### INDUSTRIAL APPLICABILITY

The present disclosure is useful as a grid computing management device, a grid computing management method, and a program that adaptively switch a transmission route for data according to a communication status with a mobile terminal.

### CROSS-REFERENCE TO RELATED APPLICATIONS

This application is based on and claims priority under 35 USC 119 from Japanese Patent Application No. 2023-053889 filed on Mar. 29, 2023, the contents of which are incorporated herein by reference.

What is claimed is:

1. A grid computing management device comprising:
a communication interface data-communicably connected with a base station/management server, the base station/management server being capable of data communication with each of a plurality of in-vehicle devices and storing a program and data necessary for executing grid computing processing by the in-vehicle device; and
a processor, wherein
the processor
acquires a communication status between a specific in-vehicle device, which is one of the plurality of in-vehicle devices, and the base station/management server, and
switches a transmission route for at least one of the program and the data based on the communication transmission from the base station/management server to the specific in-vehicle device.

2. The grid computing management device according to claim 1, wherein
when the communication status satisfies a first condition indicating a good state, the processor instructs direct transmission of the program and the data from the base station/management server to the specific in-vehicle device.

3. The grid computing management device according to claim 2, wherein
the communication status includes a communication strength between the base station/management server and the specific in-vehicle device and a data traffic of the base station/management server, and
when the communication strength is equal to or greater than a first threshold and the data traffic is less than an upper limit value, the processor determines that the communication status satisfies the first condition.

4. The grid computing management device according to claim 1, wherein
when the communication status satisfies a second condition indicating a state in which communication is difficult, the processor instructs direct transmission of one of the program and the data from the base station/management server to the specific in-vehicle device, and further instructs the base station/management server to transmit the other of the program and the data to the specific in-vehicle device through vehicle-to-vehicle communication via another in-vehicle device which is an in-vehicle device other than the specific in-vehicle device among the plurality of in-vehicle devices and is an in-vehicle device capable of data communication with both the specific in-vehicle device and the base station/management server.

5. The grid computing management device according to claim 4, wherein
the communication status includes a communication strength between the base station/management server and the specific in-vehicle device and a data traffic of the base station/management server, and
the processor determines that the communication status satisfies the second condition when the communication strength is less than a first threshold or the communication strength is equal to or greater than the first threshold and the data traffic is an upper limit value.

6. The grid computing management device according to claim 1, wherein
when the communication status satisfies a third condition indicating a communication disabled state, the processor instructs the base station/management server to transmit the program and the data to the specific in-vehicle device through vehicle-to-vehicle communication via another in-vehicle device which is an in-vehicle device other than the specific in-vehicle device among the plurality of in-vehicle devices and is an in-vehicle device capable of data communication with both the specific in-vehicle device and the base station/management server.

7. The grid computing management device according to claim 6, wherein
the communication status at least includes a communication strength between the base station/management server and the specific in-vehicle device, and
when the communication strength is less than a second threshold, the processor determines that the communication status satisfies the third condition.

8. The grid computing management device according to claim 4, wherein
the processor selects, as the another in-vehicle device among the plurality of in-vehicle devices, an in-vehicle device which is an in-vehicle device other than the specific in-vehicle device among the plurality of in-vehicle devices, is an in-vehicle device capable of data communication with both the specific in-vehicle device and the base station/management server, and is mounted on one or more other vehicles traveling in the same direction as a specific vehicle on which the specific in-vehicle device is mounted.

9. The grid computing management device according to claim 1, wherein
when the communication status is less than a third threshold, the processor determines whether switching of the transmission route for at least one of the program and the data is necessary, and switches the transmission route based on a determination result thereof.

10. The grid computing management device according to claim 1, wherein
the grid computing management device is disposed on a base station side capable of data communication with each of the plurality of in-vehicle devices.

11. The grid computing management device according to claim 1, wherein
the grid computing management device is disposed in a vehicle on which any one in-vehicle device of the plurality of in-vehicle devices is mounted, and
the communication interface is capable of data communication with the in-vehicle device disposed in the vehicle.

12. A transmission route switching method executed by a grid computing management device, the transmission route switching method comprising:
data-communicably connecting to a base station/management server that is capable of data communication with each of a plurality of in-vehicle devices and stores a program and data necessary for executing grid computing processing by the in-vehicle device;
acquiring a communication status between a specific in-vehicle device, which is one of the plurality of in-vehicle devices, and the base station/management server; and
switching a transmission route for at least one of the program and the data based on the communication status and instructing transmission from the base station/management server to the specific in-vehicle device.

13. A computer readable storage medium on which a program is stored, the program for causing a grid computing management device, which is a computer, to implement
processing of data-communicably connecting to a base station/management server that is capable of data communication with each of a plurality of in-vehicle devices and stores a program and data necessary for executing grid computing processing by the in-vehicle device;
processing of acquiring a communication status between a specific in-vehicle device, which is one of the plurality of in-vehicle devices, and the base station/management server, and
processing of switching a transmission route for at least one of the program and the data based on the communication status, and instructing transmission from the base station/management server to the specific in-vehicle device.
